(19) United States
(12) Patent Application Publication
(10) Pub. No.: US 2024/0365194 A1
(43) Pub. Date: Oct. 31, 2024

(54) SEAMLESS HANDOVER OF WIRELESS CONNECTIONS USING LOW-THROUGHPUT COMMUNICATION DEVICES, INCLUDING RELATED METHODS AND APPARATUSES

(71) Applicant: Microchip Technology Incorporated, Chandler, AZ (US)

(72) Inventor: Gerhard Willbold, Holzheim (DE)

(21) Appl. No.: 18/647,160

(22) Filed: Apr. 26, 2024

Related U.S. Application Data
(60) Provisional application No. 63/499,177, filed on Apr. 28, 2023.

(51) Int. Cl. H04W 36/18; H04W 36/00; H04W 52/40

(52) U.S. Cl. CPC H04W 36/18; H04W 36/0011; H04W 36/035; H04W 52/40

(57) ABSTRACT

A method of a controller comprises receiving a first message from a peripheral device that operates in a receiving and transmitting mode for communication of data over a wireless connection with a central device; sending a second message to respective ones of one or more other peripheral devices, the second message indicating a command to synchronize with the wireless connection in a receiving-only mode; and at least partially responsive to identifying a handover condition, sending a third message to a respective one of the one or more other peripheral devices, the third message indicating a command to switch to the receiving and transmitting mode for communication of data over the wireless connection with the central device.

### CROSS-REFERENCE TO RELATED APPLICATION

This application claims the benefit under 35 U.S.C. § 119 (e) of U.S. Provisional Patent Application No. 63/499,177, filed Apr. 28, 2023, and titled “Seamless Handover Of Wireless Connections Using Low-Throughput Communication Devices,” the entire disclosure of which is hereby incorporated herein by reference.

### TECHNICAL FIELD

Examples relate, generally, to wireless communications. More specifically, some examples relate to handover of wireless connections using low-throughput, wireless communication devices, without limitation.

### BACKGROUND

A communication system may include a controller connected to multiple peripheral devices. The peripheral devices may be short-range, low-power, low-throughput wireless communication devices. A central device may wirelessly connect to one of the peripheral devices for communication with the controller. When the location of the central device changes, the wireless connection with the peripheral device may be broken, and the central device will reconnect to another peripheral device. A disconnect-and-reconnect approach is used for changing the wireless connection. Such an approach, however, may result in a time gap within which no communication is possible.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1A and FIG. 1B are pictorial diagrams of a communication system that is known by the inventor of this disclosure;

FIG. 2A and FIG. 2B are pictorial diagrams of a communication system for seamless handover of wireless connections, according to one or more examples;

FIG. 3 is an illustrative representation of a BLUETOOTH® Low Energy (BLE) architecture including a Host Command Interface (HCI), according to a BLUETOOTH® Core Specification;

FIG. 4 is a table of vendor-specific commands of the HCI to efficiently achieve seamless handover of wireless connections, according to one or more examples;

FIGS. 5A, 5B, 5C, and 5D are respective message flow diagrams of respective example message flow sequences of messages communicated amongst devices of the communication system of FIGS. 2A and 2B, according to one or more examples;

FIG. 6 is a timing diagram of messaging associated with the message flow diagrams of FIG. 5C and FIG. 5D, according to one or more examples;

FIG. 7 is a flowchart for describing a method of performing communication operations for seamless handover of a wireless connection, according to one or more examples;

FIG. 8 is a flowchart for describing a method of performing communication operations for seamless handover of a wireless connection, according to one or more examples;

FIG. 9 is a flowchart for describing a method of performing communication operations for seamless handover of a wireless connection, according to one or more examples;

FIG. 10A is an example packet structure, format and definition of an HCI command packet for a vendor-specific command referred to as HCI_MANU_BLE_HANDOVER_1, according to one or more examples;

FIG. 10B is an example packet structure, format and definition of an HCI event packet for a vendor-specific event referred to as HCI_MANU_BLE_HANDOVER_1, according to one or more examples;

FIG. 11A is an example packet structure, format and definition of an HCI command packet for a vendor-specific command referred to as HCI_MANU_BLE_HANDOVER_2, according to one or more examples;

FIG. 11B is an example packet structure, format and definition of an HCI event packet for a vendor-specific event referred to as HCI_MANU_BLE_HANDOVER_2, according to one or more examples;

FIG. 12A is an example packet structure, format and definition of an HCI command packet for a vendor-specific command referred to as HCI_MANU_BLE_HANDOVER_3, according to one or more examples;

FIG. 12B is an example packet structure, format and definition of an HCI event packet for a vendor-specific event referred to as HCI_MANU_BLE_HANDOVER_3, according to one or more examples;

FIG. 13 is an overview of lower software layers of a software stack which may be utilized in the methods, apparatus, and systems described herein, according to one or more examples;

FIG. 14 is a schematic block diagram of a radio frequency (RF) subsystem which may be utilized in the methods, apparatus, and systems described herein, according to one or more examples; and

FIG. 15 illustrates a block diagram of a device that may be used to implement various functions, operations, acts, processes, or methods, according to one or more examples.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. In this description, the term “connected” is used interchangeably with the term “coupled,” and has the same meaning, unless expressly indicated otherwise or the context would indicate otherwise to a person having ordinary skill in the art.

A communication system may include a controller connected to multiple peripheral devices. For example, the peripheral devices may be short-range, low-power, low-throughput wireless communication devices, and more particularly, BLUETOOTH® Low Energy (BLE) devices operative to communicate according to a BLE protocol. In this environment, a central BLE device may wirelessly connect to one of the peripheral BLE devices for communicating with the controller. The central BLE device may be, or be part of, a mobile communication device (e.g., a smartphone or a tablet computer). When the location of the central BLE device changes, the wireless connection with the peripheral BLE device may be broken, and the central BLE device will reconnect to another peripheral BLE device. Here, a disconnect and reconnect approach is utilized for changing the wireless connection. Such an approach, however, may result in a time gap (e.g., even a relatively very short time gap) within which no communication is possible.

In a specific, non-limiting example of contemplated applications, the controller is operative to invoke vehicle access control functions for a vehicle responsive to signals received from the central BLE device via one of the peripheral BLE devices. In one or more examples, the vehicle access control functions include functions for smart vehicle access, with a driver's mobile device (e.g., smartphone) functioning as a virtual key (“Key”) and the controller functioning to recognize secure information to invoke specific vehicle access control functions of a vehicle (“Car”) (e.g., functions such as lock, unlock, engine start, and so on).

Various examples described herein relate to communication operations to facilitate handover with seamless connection switching between a central BLE device and two or more peripheral BLE devices. In one or more examples, the communication operations are performed without the central BLE device notifying of handover changes. In one or more examples, the communication operations for handover ensure a (substantially) continuous wireless connection between the central BLE device and the two or more peripheral BLE devices.

In a specific, non-limiting example associated with a vehicular application, the “Key” may be always connected to the “Car” using the best connection (e.g., via the peripheral BLE device associated with the highest signal strength), without the need for notification of disconnection and/or reconnection.

More particularly, one or more examples described herein involve communication operations for synchronization of peripheral BLE devices to an existing wireless connection in a “passive” mode of operation, and for switching of the peripheral BLE devices between “active” and “passive modes” to facilitate handover. In one or more examples, a receive synchronization mechanism of the BLE protocol is utilized to synchronize the “passive” peripheral BLE devices with the existing wireless connection associated with the “active” peripheral BLE device. Once synchronization is complete, all of the peripheral BLE devices may receive communications from the central BLE device.

In one or more examples, only the peripheral BLE device in the active mode transmits information back to the central BLE device; the peripheral BLE devices in the passive mode only receive information from the central BLE device and do not transmit any response. In one or more examples, such response “muting” may be implemented by reducing the transmit power setting of the BLE radio to a minimum, or alternatively by switching off the transmit power or transmitter completely.

In one or more examples, the peripheral BLE devices may obtain Received Signal Strength Indication (RSSI) information from the central BLE device and convey that information to the controller. The controller may perform handover operations at least partially responsive to the conveyed RSSI information. For example, the controller may set the peripheral BLE device having the highest RSSI as the “active” peripheral BLE device and the other remaining peripheral BLE devices as “passive” peripheral BLE devices. In one or more examples, information different from RSSI information may be utilized, such as location information or distance information.

Thus, in one or more examples, when connection switching is processed, the peripheral BLE device in the active mode is set to the passive mode of operation (e.g., its transmit power is substantially reduced or switched off). On the other hand, a peripheral BLE device in the passive mode having the best signal strength, location, or distance is set to the active mode of operation (e.g., its transmit power is restored or switched on).

In one or more examples, handover operations may be controlled by BLE host software. In one or more examples, synchronization and switching may be performed in BLE controller software. In one or more examples, a Host Controller Interface (HCI) is used for communication between the controller and the peripheral BLE devices.

In one or more examples, communication and control between BLE host software and BLE controller software for seamless handover is achieved efficiently by extending the HCI with vendor-specific HCI commands. In one or more examples, the vendor-specific commands may be used for synchronization of peripheral BLE devices to an existing wireless connection and switching between active and passive modes of operation.

Accordingly, the communication operations for handover according to one or more examples may facilitate a fast and seamless connection switching between a central BLE device and two or more peripheral BLE devices. In one or more examples, the communication operations for handover may be applied to vehicular access applications or other applications, such as range extension applications (e.g., for industrial applications), and so on, without limitation.

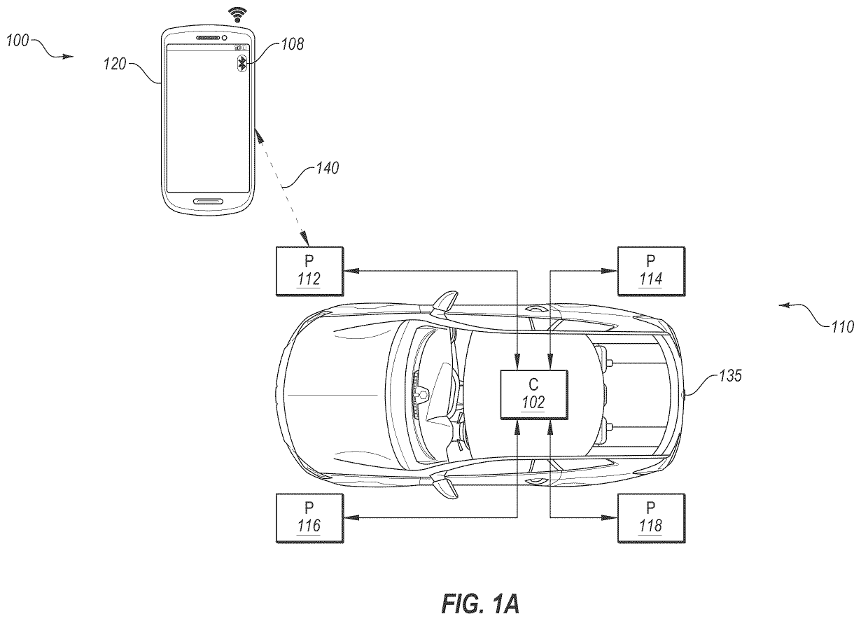

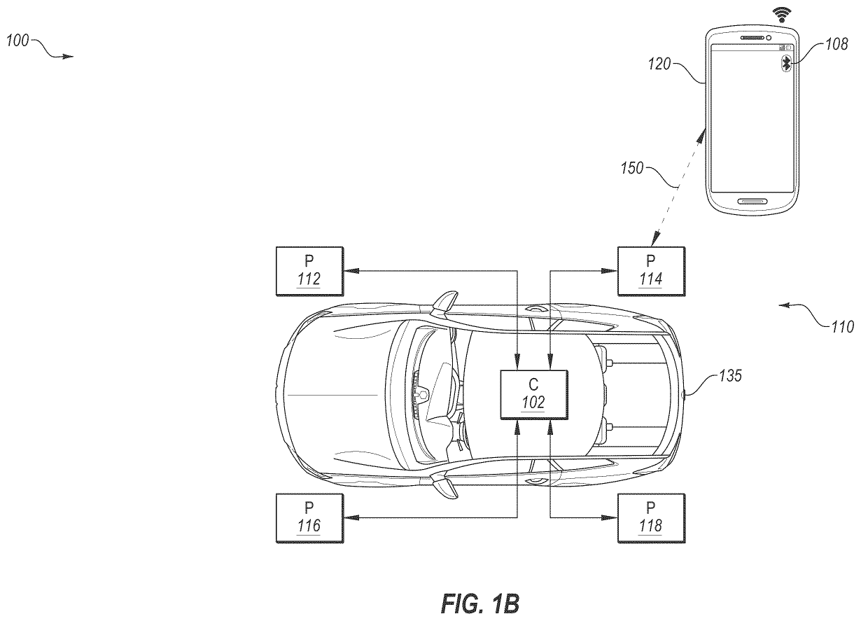

FIG. 1A is a pictorial diagram of a communication system 100 that is known by the inventor of this disclosure. Communication system 100 includes a controller 102 (e.g., “C”), multiple peripheral devices 110 (“P”), and a central device 108. Controller 102 is operably connected to respective ones of multiple peripheral devices 110 via respective connections, such as wired connections. In one or more examples, the wired connections may be provided via a Controller Area Network (CAN) interface, a Universal Asynchronous Receiver/Transmitter (UART) interface, or a single-pair interface. Respective ones of multiple peripheral devices 110 may be short-range, low-throughput, wireless communications devices. In FIG. 1A, multiple peripheral devices 110 include four (4) peripheral devices, including a peripheral device 112, a peripheral device 114, a peripheral device 116, and a peripheral device 118.

Central device 108 operates to wirelessly communicate with respective ones of multiple peripheral devices 110. In particular, central device 108 is to wirelessly connect to one of multiple peripheral devices 110 for communicating with controller 102. Central device 108 may be, or be part of, a mobile communication device 120. In one or more examples, mobile communication device 120 is a battery-powered, portable communication device (e.g., a smartphone).

In one or more examples, central device 108 and respective ones multiple peripheral devices 110 communicate with each other according to the BLE protocol, and may be referred to as BLE devices. In addition, controller 102, central device 108, and respective ones multiple peripheral devices 110 to communicate according to the BLE protocol communicate commands and events according to the HCI.

In the specific application of FIG. 1A, controller 102 is operative to invoke vehicle access control functions for a vehicle 135 responsive to signals received from central device 108 via a respective one of the peripheral devices 112, 114, 116, and 118. Here, controller 102 may be referred to as a car controller.

In FIG. 1A, central device 108 is shown to be positioned at a first location (e.g., closest in proximity to peripheral device 112). At the first location, central device 108 has a wireless connection 140 with peripheral device 112 to provide communication between central device 108 and controller 102. No wireless connections are established between central device 108 and the other peripheral devices, including peripheral device 114, peripheral device 116, and peripheral device 118.

In FIG. 1B, central device 108 is shown to be moved to and positioned at a second location (e.g., now closest in proximity to peripheral device 114) different from the first location. At the second location, central device 108 has a wireless connection 150 with peripheral device 114 to provide communication between central device 108 and controller 102. No wireless connections are established between central device 108 and the other peripheral devices, including peripheral device 112, peripheral device 116, and peripheral device 118.

In the process of central device 108 being moved from the first location (FIG. 1A) to the second location (FIG. 1B), wireless connection 140 with peripheral device 112 (FIG. 1A) is broken or disconnected. The disconnection occurs prior to wireless connection 150 being established with peripheral device 114 (FIG. 1B). At least in some cases, the handover process may result in a time gap (e.g., even a relatively very short time gap) within which no communication is possible.

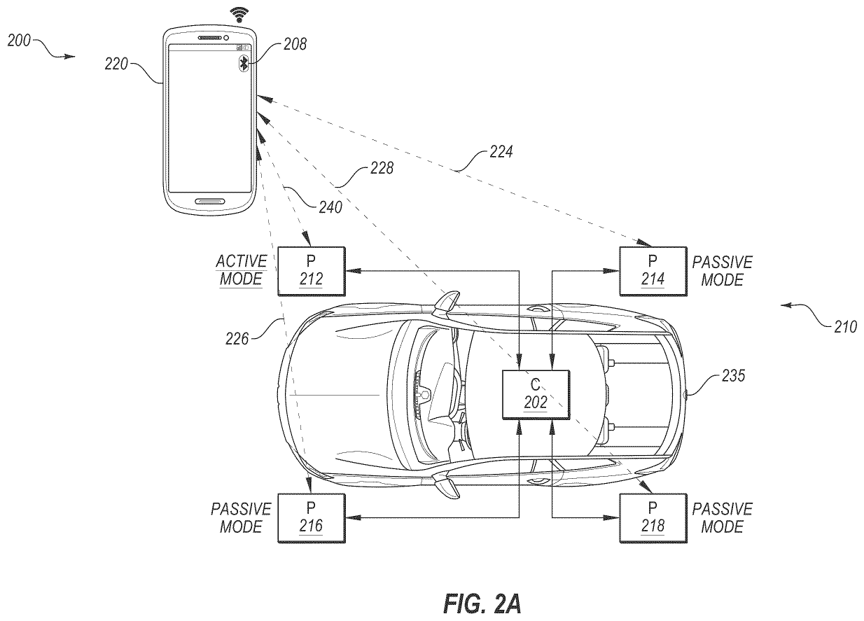

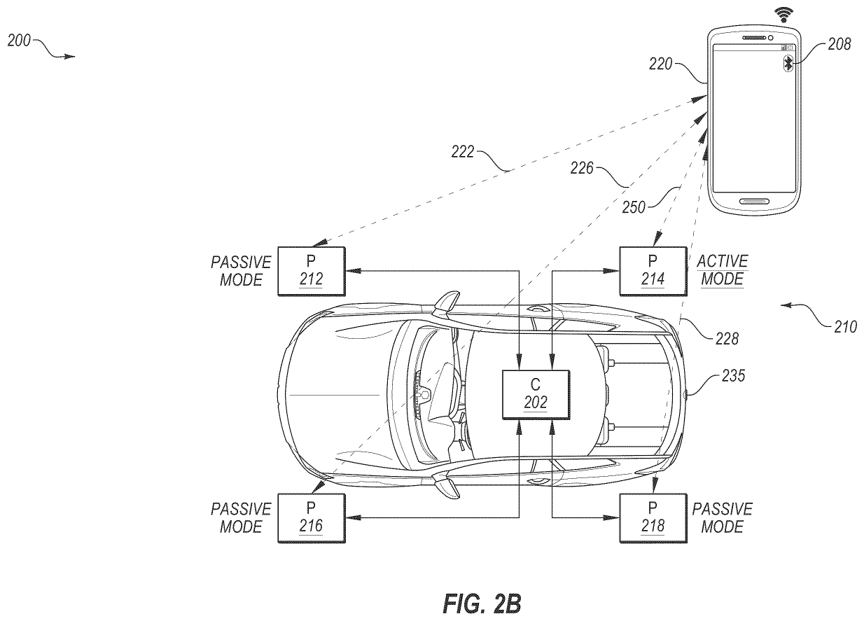

FIG. 2A is a pictorial diagram of a communication system 200 for seamless handover of wireless connections, according to one or more examples of the disclosure.

Communication system 200 includes a controller 202 (“C”), multiple peripheral devices 210 (“P”), and a central device 208. Controller 202 is operably connected to respective ones of multiple peripheral devices 210 via respective connections, such as wired connections. In one or more examples, the wired connections may be provided via a CAN interface, a UART interface, or a single-pair interface, without limitation. Respective ones of multiple peripheral devices 210 may be short-range, low-throughput, wireless communications devices. Multiple peripheral devices 210 may alternatively be referred to as wireless devices, peripheral nodes, or nodes. In FIG. 2A, multiple peripheral devices 210 include four (4) peripheral devices, including a peripheral device 212, a peripheral device 214, a peripheral device 216, and a peripheral device 218. In one or more examples, communication system 200 may include more than, or less than, four (4) peripheral devices.

Central device 208 is to wirelessly communicate with respective ones of multiple peripheral devices 210. In particular, central device 208 is to wirelessly connect to one of the peripheral devices 210 for communicating with controller 202. Central device 208 may be, or be part of, a mobile communication device 220 (hereinafter “mobile device 220”). In one or more examples, mobile device 220 is a battery-powered, portable communication device. In one or more examples, mobile device 220 may be a cellular telephone, a smartphone, a tablet computer (“tablet”), a key fob, a wireless speaker, a wearable device, and so on, without limitation.

In one or more examples, central device 208 and respective ones multiple peripheral devices 210 communicate with each other according to the BLE protocol, and may be referred to as BLE devices. In addition, controller 202, central device 208, and respective ones multiple peripheral devices 210 that communicate according to the BLE protocol are to communicate commands and events according to the HCI.

In the specific application of FIG. 2A, controller 202 is operative to invoke vehicle access control functions for a vehicle 235 responsive to signals received from central device 208 via a respective one of the peripheral devices 212, 214, 216, and 218. In one or more specific examples, the vehicle access control functions may include functions for smart vehicle access, with the driver's mobile device 220 (e.g., a smartphone) functioning as a virtual key (“Key”) and controller 202 (“Car Controller” or “CC”) functioning to recognize secure information to invoke specific vehicle access control functions in relation to vehicle 235 (“Car”) (e.g., functions such as lock, unlock, engine start, and so on).

In FIG. 2A, central device 208 is shown to be positioned at a first location (e.g., closest in proximity to peripheral device 212). At the first location, central device 208 has a wireless connection 240 with peripheral device 212 to provide communication between central device 208 and controller 202. Here, peripheral device 212 operates in an “active mode” of communication with central device 208. In one or more examples, the active mode of peripheral device 212 may be a receiving and transmitting mode for communication of data over wireless connection 240 with central device 208. In one or more examples, controller 202 operates to invoke vehicle access control functions for vehicle 235 responsive to signals received from central device 208/mobile device 220 via peripheral device 212.

On the other hand, respective ones of peripheral device 214, peripheral device 216, and peripheral device 218 operate in a “passive mode” of communication. In one or more examples, the passive mode may be a receiving-only mode of communication in which respective ones of peripheral device 214, peripheral device 216, and peripheral device 218 are synchronized with wireless connection 240 of central device 208 for receiving data from central device 208. In the receiving-only modes of FIG. 2A, peripheral device 214 receives the data from central device 208 over a receive-only connection 224, peripheral device 216 receives the data from central device 208 over a receive-only connection 226, and peripheral device 218 receives the data from central device 208 over a receive-only connection 228. These receive-only connections may be alternatively referred to as receive-only channels, synchronized reception channels, and so on. In one or more examples, in the receiving-only mode, respective ones of peripheral device 214, peripheral device 216, and peripheral device 218 may operate a respective transmitter in a reduced transmit power mode or in a powered down transmitter mode. In one or more examples, in the receiving-only mode, respective ones of peripheral device 214, peripheral device 216, and peripheral device 218 receive and discard payload data (e.g., at least some, most, or all data) received over wireless connection 240 with central device 208.

In FIG. 2B, central device 208 is shown to be moved to and positioned at a second location (e.g., now closest in proximity to peripheral device 214) different from the first location. At the second location, central device 208 has a wireless connection 250 with peripheral device 214 to provide communication between central device 208 and controller 202. Here, peripheral device 214 operates in the “active mode” of communication with central device 208. Again, in one or more examples, the active mode may be a receiving and transmitting mode of peripheral device 214 for communication of data over wireless connection 250 with central device 208. In one or more examples, controller 202 now operates to invoke vehicle access control functions for vehicle 235 responsive to signals received from central device 208/mobile device 220 via peripheral device 214.

On the other hand, respective ones of peripheral device 212, peripheral device 216, and peripheral device 218 operate in the “passive mode” of communication. In one or more examples, the passive mode may be a receiving-only mode of communication where respective ones of peripheral device 212, peripheral device 216, and peripheral device 218 are synchronized with wireless connection 250 of central device 208 for receiving data from central device 208. In the receiving-only modes of FIG. 2B, peripheral device 212 receives the data from central device 208 over a receive-only connection 222, peripheral device 216 receives the data from central device 208 over receive-only connection 226, and peripheral device 218 receives the data from central device 208 over receive-only connection 228. These receive-only connections may be alternatively referred to as receive-only channels, synchronized reception channels, and so on. In one or more examples, in the receiving-only mode, respective ones of peripheral device 212, peripheral device 216, and peripheral device 218 operate a respective transmitter in a reduced transmit power mode or in a powered down transmitter mode. In one or more examples, in the receiving-only mode, respective ones of peripheral device 212, peripheral device 216, and peripheral device 218 receive and discard payload data (e.g., at least some, most, or all data) received over wireless connection 250 with central device 208.

While central device 208 is moved from the first location (FIG. 2A) to the second location (FIG. 2B), wireless communications are (e.g., more) seamlessly maintained. Communications may be switched or changed from peripheral device 212 to peripheral device 214 without use of the previously-described disconnect and reconnect approach. For example, data from central device 208 may be received at peripheral device 214 (e.g., and forwarded to controller 202 for processing) even when communications between central device 208 and peripheral device 212 (e.g., begin to) become less optimal, poor, or even broken. In one or more examples, the communication processing for handover may result in little or no dead time for (e.g., substantially) seamless communication in the system.

As described above, controller 202, central device 208, and respective ones multiple peripheral devices 210 that communicate according to the BLE protocol may communicate commands and events according to the HCI. In one or more examples, the communication of commands and events of the HCI is implemented according to the BLUETOOTH® Core Specification (hereinafter referred to as the “BTCS”), Version 5.4 having revision date of 2023 Feb. 7, which is hereby incorporated by referenced herein in its entirety. In general, the BTCS describes concepts that collectively constitute a data transport architecture, including a physical transport, a physical channel, a physical link, a logical link, and a logical transport. BLUETOOTH® is a registered trademark of the Bluetooth Special Interest Group (SIG), Inc., of Kirkland, Washington, USA.

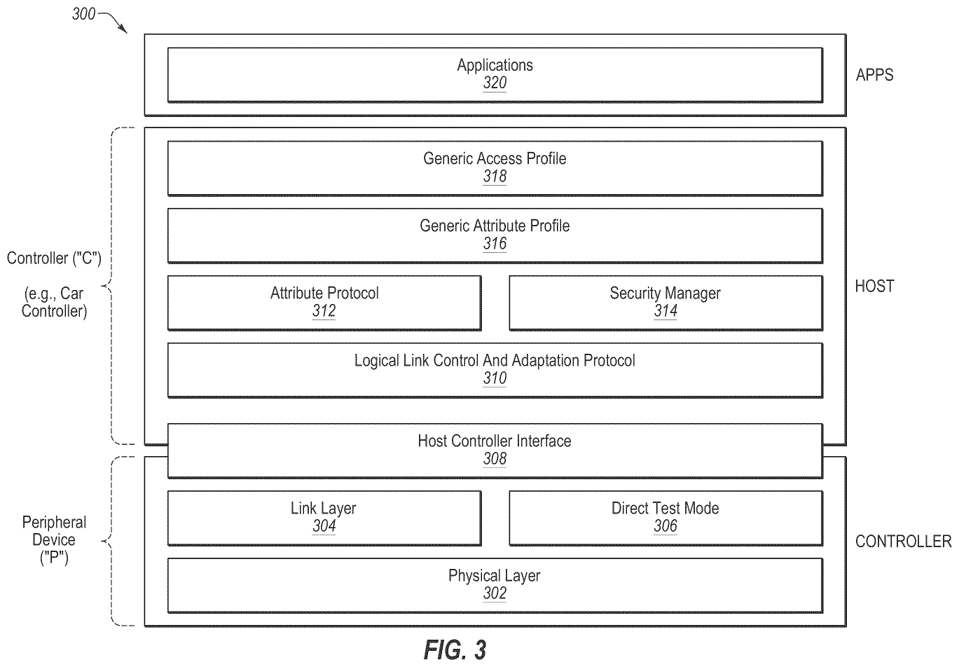

FIG. 3 is an illustrative representation of a BLE architecture 300 including a Host Command Interface (HCI), according to the BTCS. BLE architecture 300 includes (from bottom to top) a physical layer 302, a link layer 304, a direct test mode layer 306 (in the same layer as link layer 304), an HCI layer 308, a logical link control and adaptation protocol layer 310, an attribute protocol layer 312, a security manager layer 314 (in the same layer as attribute protocol layer 312), a generic attribute profile layer 316, a generic access profile layer 318, and an applications layer 320.

A peripheral device (e.g., respective ones of peripheral device 212, peripheral device 214, peripheral device 216, and peripheral device 218 of FIG. 2A and FIG. 2B) may implement a “CONTROLLER” portion of BLE architecture 300: one or more of physical layer 302, link layer 304, and HCI layer 308. A controller (e.g., controller 202 of FIG. 2A and FIG. 2B) may implement a “HOST” portion of BLE architecture 300: one or more of HCI layer 308, logical link control and adaptation protocol layer 310, attribute protocol layer 312, security manager layer 314 (in the same layer as attribute protocol layer 312), generic attribute profile layer 316, and generic access profile layer 318.

Commands and events of HCI layer 308 include predefined commands and events according to the predefined specification (e.g., the BTCS). In addition, the commands and the events of HCI layer 308 include vendor-specific commands and events allowed by the predefined specification. In one or more examples, communication and control between BLE host software (e.g., a controller) and BLE controller software (e.g., a peripheral device) for seamless handover is efficiently achieved efficiently by extending the HCI with vendor-specific HCI commands. In one or more examples, vendor-specific commands may be used for synchronization of peripheral BLE devices to an existing wireless connection and switching between active and passive modes of the peripheral BLE devices.

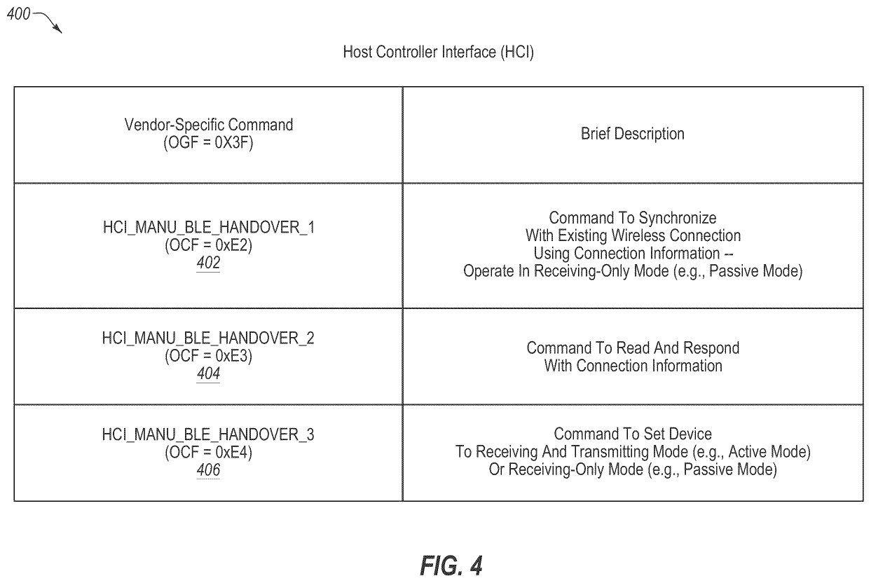

FIG. 4 is a table 400 of vendor-specific commands of the HCI to efficiently achieve seamless handover of wireless connections, according to one or more examples.

Table 400 indicates vendor-specific commands including a command 402 referred to as HCI_MANU_BLE_HANDOVER_1, a command 404 referred to as HCI_MANU_BLE_HANDOVER_2, and a command 406 referred to as HCI_MANU_BLE_HANDOVER_3.

Command 402 associated with HCI_MANU_BLE_HANDOVER_1 is a command for a device to synchronize with an existing wireless connection using connection information. Command 402 may be a command for a device to operate in a receiving-only mode of operation (e.g., a passive mode of operation). In one or more examples, the connection information (e.g., one or more parameters of the existing wireless connection) is included with the command.

Command 404 associated with HCI_MANU_BLE_HANDOVER_2 is a command for a device to read and respond with connection information associated with an existing wireless connection.

Command 406 associated with HCI_MANU_BLE_HANDOVER_3 is a command to set (or switch) a device to a receiving and transmitting mode of operation (e.g., an active mode of operation) when the command includes a first indication. On the other hand, command 406 associated with HCI_MANU_BLE_HANDOVER_3 is a command to set (or switch) a device to a receiving-only mode of operation (e.g., a passive mode of operation) when the command includes a second indication.

According to one or more examples, packet structures, formats and definitions associated with the vendor-specific commands and events for FIG. 4 are shown and described later in relation to FIGS. 10A-10B, FIGS. 11A-11B, and FIGS. 12A-1B.

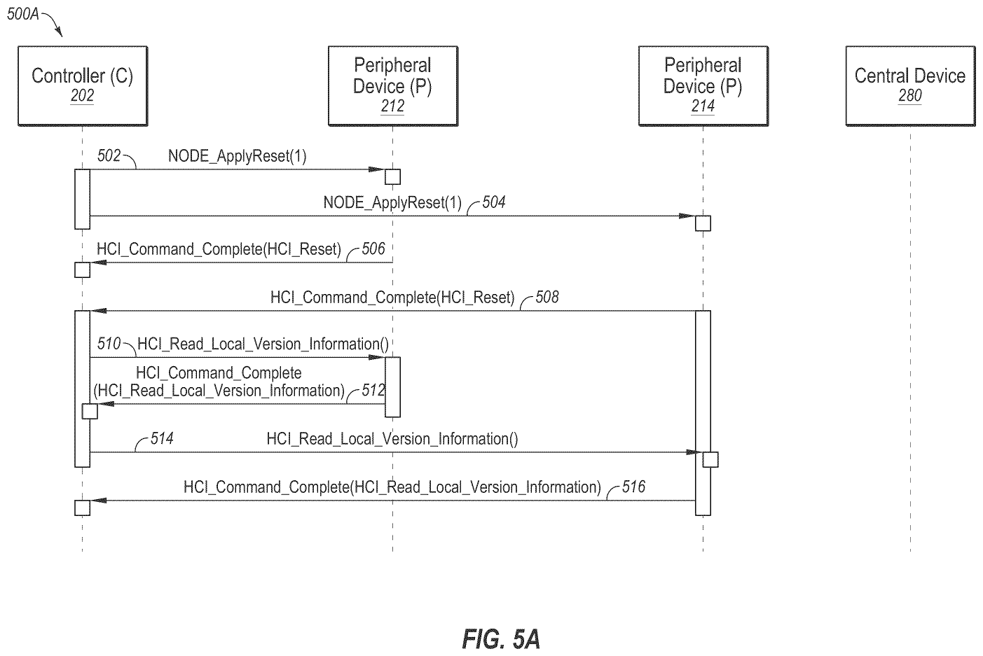

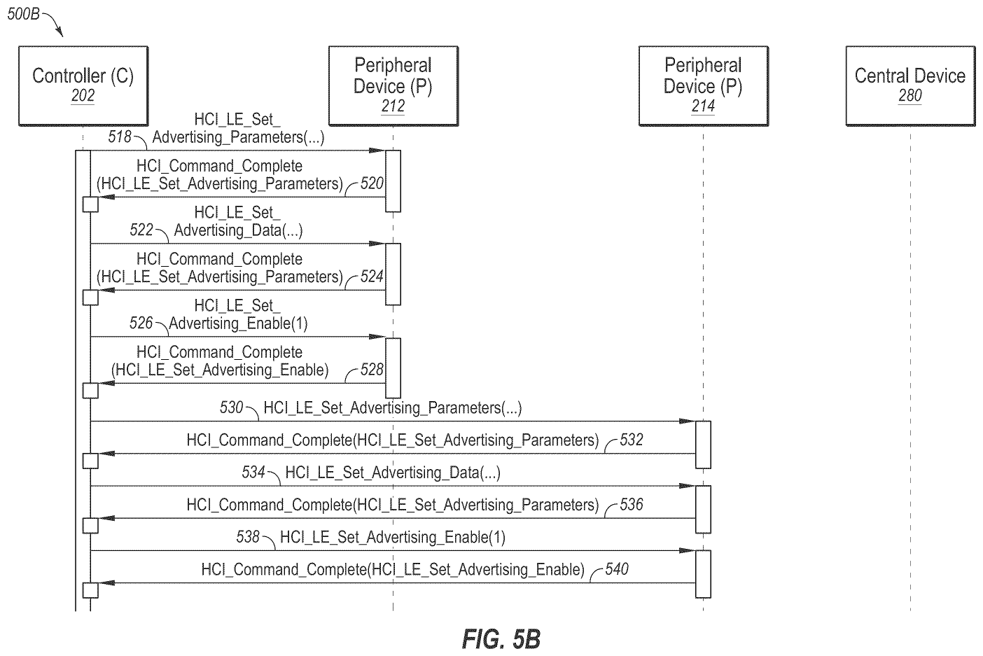

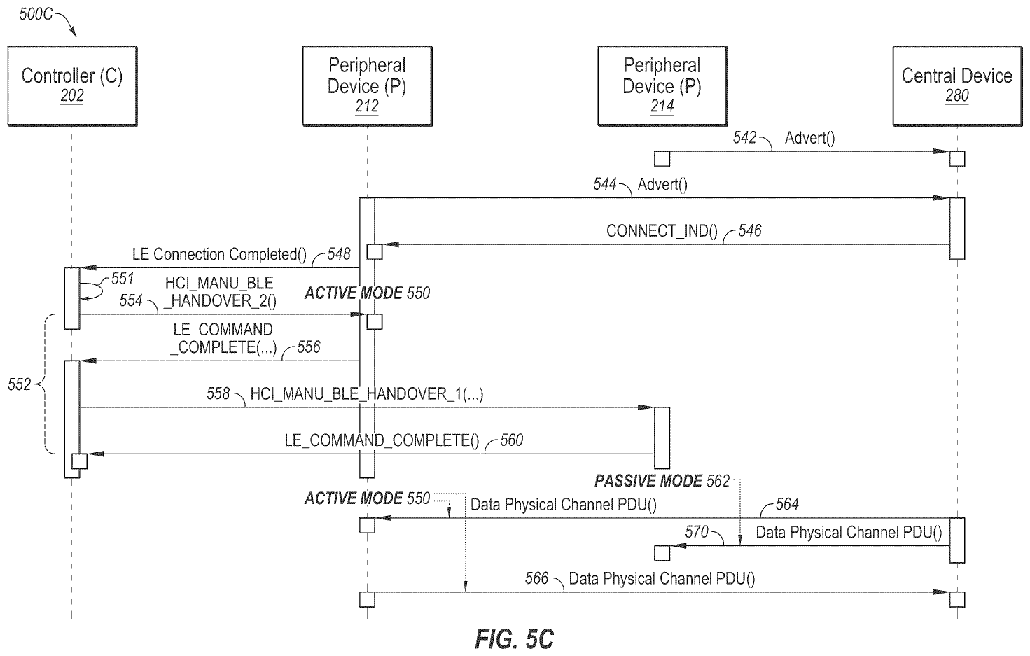

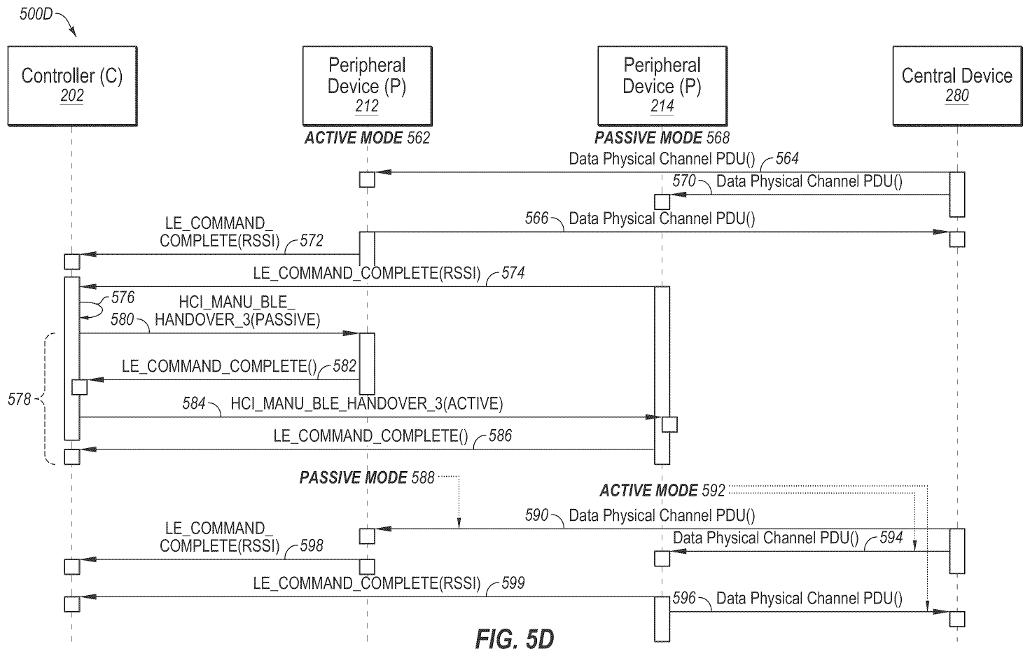

FIGS. 5A 5B, 5C, and 5D are respective message flow diagrams 500A, 500B, 500C, and 500D of respective example message flow sequences of messages communicated amongst devices of a communication system, according to one or more examples.

As illustrated, the message flow sequences of message flow diagrams 500A, 500B, 500C, and 500D are performed in communication system 200 of FIGS. 2A and 2B, and more particularly, in communication system 200 of FIGS. 2A and 2B including controller 202, mobile device 220, and peripheral devices 212 and 214 (without peripheral devices 216 and 218). In one or more examples, one or more additional peripheral devices may be utilized in the message flow sequences (e.g., including all of multiple peripheral devices 210 of FIGS. 2A and 2B). The message flow sequences of message flow diagrams 500A, 500B, 500C, and 500D may be performed in sequence.

FIG. 5A is a message flow diagram of message flow sequence 500A for initialization procedures in a communication system, according to one or more examples. In general, message flow sequence 500A includes the communication of “Apply Reset” commands and “Read Local Version Information” commands to the peripheral devices, and the responses of the peripheral devices to such commands.

At an act 502, controller 202 sends a message indicating a command to apply a reset to peripheral device 212. Similarly, at an act 504, controller 202 sends a message indicating a command to apply a reset to peripheral device 214. Responsive to the command, peripheral device 212 performs a reset and, at an act 506, sends a message indicating a response or event to confirm the reset to controller 202. Similarly, responsive to the command, peripheral device 214 performs a reset and, at an act 508, sends a message indicating a response or event to confirm the reset to controller 202. In one or more examples, act 502 and act 504 are associated with respective HCI commands indicating NODE_ApplyReset(1), and act 506 and act 508 are associated with respective HCI events indicating HCI_Command_Complete (HCI_Reset).

At an act 510, controller 202 sends a message indicating a command to read local version information to peripheral device 212. Responsive to the command, peripheral device 212 performs a reading of the local version information and, at an act 512, sends a message indicating a response or event including the information to controller 202. Similarly, at an act 514, controller 202 sends a message indicating a command to read local version information to peripheral device 214. Responsive to the command, peripheral device 214 performs a reading of the local version information and, at an act 516, sends a message indicating a response or event including the information to controller 202. In one or more specific examples, act 510 and act 514 are associated with respective HCI commands indicating HCI_Read_Local_Version_Information, and act 512 and act 516 are associated with respective HCI events indicating HCI_Command_Complete (HCI_Read_Local_Version_Information).

FIG. 5B is a message flow diagram of a message flow sequence 500B for initiating advertisements of peripheral devices in the communication system, according to one or more examples. In general, message flow sequence 500B includes the communication of “Set Advertising Parameter” commands, “Set Advertising Data” commands, and “Set Advertising Enable” commands to the peripheral devices, and the responses of the peripheral devices to such commands. The message flow sequence of message flow diagram 500B may follow message flow diagram 500A of FIG. 5A.

At an act 518, controller 202 sends a message indicating a command to set advertising parameters to peripheral device 212. Responsive to the command, peripheral device 212 sets the advertising parameters and, at an act 520, sends a message indicating a response or event to confirm the same to controller 202. At an act 522, controller 202 sends a message indicating a command to set advertising data to peripheral device 212. Responsive to the command, peripheral device 212 sets the advertising data and, at an act 524, sends a message indicating a response or event to confirm the same to controller 202. At an act 526, controller 202 sends a message indicating a command to set an advertising enable to peripheral device 212. Responsive to the command, peripheral device 212 sets the advertising enable and, at an act 528, sends a message indicating a response or event to confirm the same to controller 202.

The communication operations performed in relation to peripheral device 212 are now performed in relation to peripheral device 214. At an act 530, controller 202 sends a message indicating a command to set advertising parameters to peripheral device 214. Responsive to the command, peripheral device 214 sets the advertising parameters and, at an act 532, sends a message indicating a response or event to confirm the same to controller 202. At an act 534, controller 202 sends a message indicating a command to set advertising data to peripheral device 214. Responsive to the command, peripheral device 214 sets the advertising data and, at an act 536, sends a message indicating a response or event to confirm the same to controller 202. At an act 538, controller 202 sends a message indicating a command to set an advertising enable to peripheral device 214. Responsive to the command, peripheral device 214 sets the advertising enable and, at an act 540, sends a message indicating a response or event to confirm the same to controller 202.

In one or more specific examples, act 520 and act 530 are associated with respective HCI commands indicating HCI_LE_Set_Advertising_Parameters, act 522 and act 534 are associated with respective HCI commands indicating HCI_LE_Set_Advertising_Data, and act 526 and act 538 are associated with respective HCI commands indicating HCI_LE_Set_Advertising_Enable. In one or more examples, act 520, act 524, act 528, act 532, act 536, and act 540 are associated with respective HCI events indicating HCI_Command_Complete.

FIG. 5C is a message flow diagram of a message flow sequence 500C of communication operations to be performed upon a wireless connection being established between a central device and a peripheral device in the communication system, according to one or more examples. The message flow sequence of message flow diagram 500C may follow message flow diagram 500B of FIG. 5B.

In general, peripheral devices 212 and 214 begin to send advertisements to solicit the establishment of a wireless connection for communication. At an act 542, peripheral device 214 sends a message indicating an advertisement, which is received at central device 280. Similarly, at an act 544, peripheral device 212 sends a message indicating an advertisement, which is received at central device 280. In response, central device 280 initiates the establishment of a wireless connection with one of the peripheral devices. In particular, at an act 546, central device 280 sends a message indicating a command to connect to peripheral device 212. In response, a wireless connection is established between central device 280 and peripheral device 212. At an act 548, peripheral device 212 sends a message indicating an event of “connection complete” to controller 202. Peripheral device 212 operates in a receiving and transmitting mode (or an active mode 550) via the wireless connection with central device 280.

In one or more specific examples, act 542 and act 544 are associated with respective HCI events indicating “Advert,” act 546 is associated with a command indicating CONNECT_IND, and act 548 is associated with an HCI event indicating LE Connection Complete.

At an act 551, controller 202 receives and detects the connection complete event from peripheral device 212. Responsive to receipt of the connection complete event, controller 202 performs a set of communication operations 552 including an act 554, an act 556, an act 558, and an act 560 (or at least act 554 and act 558). At act 554, controller 202 sends a message indicating a command to read and respond with connection information to peripheral device 212. In one or more examples, the command to read and respond with connection information is a vendor-specific command of the HCI (e.g., command 404 of FIG. 4, or HCI_MANU_BLE_HANDOVER_2). In response, peripheral device 212 reads and responds with connection information associated with the wireless connection. In particular, at an act 556, peripheral device 212 sends a message indicating an event to include parameters of the wireless connection to controller 202 (e.g., LE_COMMAND_COMPLETE).

In response, at act 558, controller 202 sends a message indicating a command to synchronize with the wireless connection using the connection information to peripheral device 214. In one or more examples, the command is to operate in a receiving-only mode (or a passive mode) to receive data over the wireless connection. In one or more examples, the command to synchronize with the wireless connection using the connection information (or operate in the receiving-only mode or passive mode) is a vendor-specific command of the HCI (e.g., command 402 of FIG. 4, or HCI_MANU_BLE_HANDOVER_1). In response, peripheral device 214 synchronizes with the wireless connection of central device 280 using the connection information. In addition, at an act 560, peripheral device 214 sends a message indicating an event of “command complete” to controller 202 (e.g., LE_COMMAND_COMPLETE).

Peripheral device 212 maintains operation in the receiving and transmitting mode (or active mode 550) with central device 280. In the receiving and transmitting mode (or active mode 550), at an act 564, central device 280 may (e.g., repeatedly) send data in a packet data unit (PDU) (a data physical channel PDU) over the wireless connection for receipt at peripheral device 212; and at an act 566, peripheral device 212 may (e.g., repeatedly) send data in a PDU (a data physical channel PDU) over the wireless connection for receipt at central device 280. Meanwhile, peripheral device 214 operates in the receiving-only mode (or a passive mode 568) with central device 280. In the receiving-only mode (or passive mode 652), at an act 570, peripheral device 214 may (e.g., repeatedly) receive the data in the PDU(s) sent from central device 280 over the wireless connection between central device 280 and peripheral device 212.

FIG. 5D is a message flow diagram of a message flow sequence 500D for steady-state communication and handover operations of the wireless connection, according to one or more examples. The message flow sequence of message flow diagram 500D may follow message flow diagram 500C of FIG. 5C.

In FIG. 5D, the receiving and transmitting mode (e.g., active mode 562) of peripheral device 212 associated with act 564 and act 566 from FIG. 5C, and the receiving-only mode (e.g., passive mode 568) of peripheral device 214 associated with act 570 from FIG. 5C, are repeated in the figure. At an act 572, peripheral device 212 may send an event indicating RSSI information to controller 202 (e.g., the RSSI between central device 280 and peripheral device 212). At an act 574, peripheral device 214 may also send an event indicating RSSI information to controller 202 (e.g., the RSSI between central device 280 and peripheral device 214). In one or more examples, the information may be different from RSSI, such as location information or distance information. Act 572 of peripheral device 212 and act 574 of peripheral device 214 may be repeated acts of operation. In one or more specific examples, act 572 and act 574 are associated with respective HCI events indicating LE_COMMAND_COMPLETE.

At an act 576, controller 202 may identify a handover condition for handing over the wireless connection. In one or more examples, controller 202 may identify a handover condition at least partially based on the RSSI information associated with peripheral device 212 and the RSSI information associated with peripheral device 214. For example, controller 202 may identify that the RSSI (e.g., as averaged over time or otherwise) of peripheral device 212 is higher than the RSSI of peripheral device 214, such that a handover of the wireless connection to peripheral device 214 should be performed. Again, in one or more examples, the information utilized for the identification of the handover condition may be different than RSSI, such as location information or distance information.

Responsive to identification or detection of the handover condition at act 576, controller 202 performs a set of communication operations 578 including an act 580, an act 582, an act 584, and an act 586 (or at least act 580 and act 584). At act 580, controller 202 sends a message indicating a command having an indication to set the device to receiving-only mode (e.g., the passive mode) to peripheral device 212. In one or more examples, the command having the indication to set the device to the receiving-only mode (e.g., the passive mode) is a vendor-specific command of the HCI (e.g., command 406 of FIG. 4, or HCI_MANU_BLE_HANDOVER_3). In response, peripheral device 212 switches from the receiving and transmitting mode (e.g., the active mode) to the receiving-only mode (e.g., the passive mode). In particular, at act 582, peripheral device 212 sends a message indicating an event to indicate that the command is completed to controller 202 (e.g., LE_COMMAND_COMPLETE).

At act 584, controller 202 sends a message indicating a command having an indication to set the device to the receiving and transmitting mode (e.g., the active mode) to peripheral device 214. In one or more examples, the command having the indication to set the device to the receiving and transmitting mode (e.g., the active mode) is a vendor-specific command of the HCI (e.g., command 406 of FIG. 4, or HCI_MANU_BLE_HANDOVER_3). In response, peripheral device 212 switches from the receiving-only mode (e.g., passive mode) to the receiving and transmitting mode (e.g., the active mode). In particular, at act 586, peripheral device 214 sends a message indicating an event to indicate that the command is completed to controller 202 (e.g., LE_COMMAND_COMPLETE).

Peripheral device 214 now operates in the receiving and transmitting mode (or an active mode 592) with central device 280. In the receiving and transmitting mode (or active mode 592), at an act 594, central device 280 may (e.g., repeatedly) send data in a PDU (a data physical channel PDU) over the wireless connection for receipt at peripheral device 214; and at an act 596, peripheral device 214 may (e.g., repeatedly) send data in a PDU (a data physical channel PDU) over the wireless connection for receipt at central device 280. Meanwhile, peripheral device 212 operates in the receiving-only mode (or a passive mode 588) with central device 280. In the receiving-only mode (or passive mode 588), at an act 590, peripheral device 212 may (e.g., repeatedly) receive the data in the PDU(s) sent from central device 280 over the wireless connection between central device 280 and peripheral device 214.

At an act 598, peripheral device 212 may send an event indicating RSSI information to controller 202 (e.g., the RSSI between central device 280 and peripheral device 212). At an act 599, peripheral device 214 may also send an event indicating RSSI information to controller 202 (e.g., the RSSI between central device 280 and peripheral device 214). In one or more examples, the information may be different from RSSI, such as location information or distance information. Act 598 of peripheral device 212 and act 599 of peripheral device 214 may be repeated acts of operation. In one or more specific examples, act 598 and act 599 are associated with respective HCI events indicating LE_COMMAND_COMPLETE.

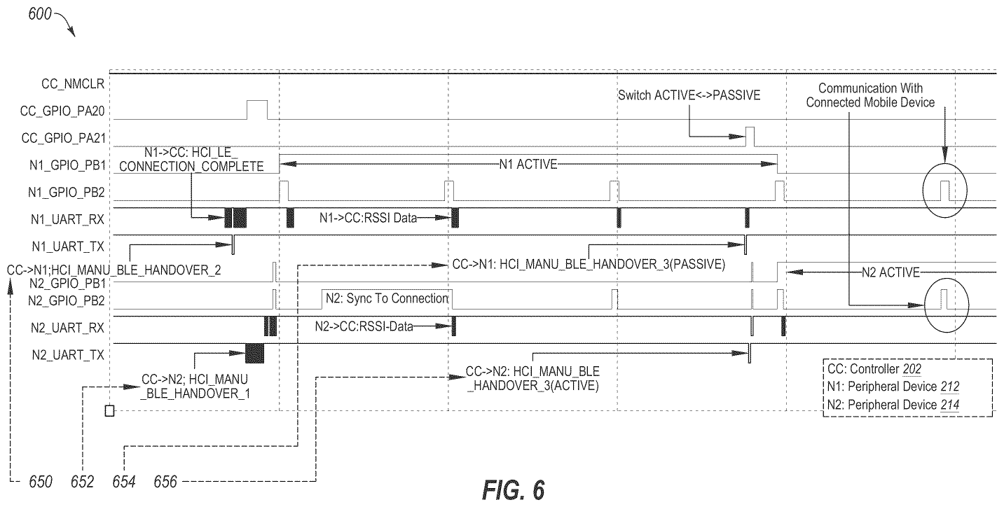

FIG. 6 is a timing diagram 600 of messaging associated with the message flow diagrams of FIG. 5C and FIG. 5D, according to one or more examples. In timing diagram 600, peripheral device 212 of the previous figures is indicated as Node 1 (N1), peripheral device 214 of the previous figures is indicated as Node 2 (N2), and controller 202 of the previous figures is indicated as Car Controller (CC).

In general, timing diagram 600 indicates the establishment of the wireless connection of N1; the configuration and the synchronization of N2 to the existing wireless connection; and responsive to the identification a handover condition, the switching of N1 from the active mode to the passive mode and the switching of N2 from the passive mode to the active mode.

In FIG. 6, a wireless connection is established between the central device and N1. A reference 650 indicates the communication of a command to read and respond with connection information (e.g., HCI_MANU_BLE_HANDOVER_2) from CC to N1, responsive to the HCI_LE_Connection_Complete from N1. N1 will operate in the active mode (“N1 ACTIVE”). A reference 652 indicates the communication of a command to synchronize with the existing connection and operate in the passive mode (e.g., HCI_MANU_BLE_HANDOVER_1) from CC to N2. N2 then synchronizes to the existing wireless connection (“Sync to Connection”) and will operate in the passive mode.

During steady-state communication operation, N1 and N2 regularly communicate RSSI data to the CC. Responsive to initiation of a handover, a reference 654 indicates the communication of a command including an indication to switch to the passive mode (e.g., HCI_MANU_BLE_HANDOVER_2 (PASSIVE)) from CC to N1. In addition, a reference 656 indicates the communication of a command including an indication to switch to the active mode (e.g., HCI_MANU_BLE_HANDOVER_2 (ACTIVE)) from CC to N2. N2 will now operate in the active mode (“N2 ACTIVE”), and N1 will operate in the passive mode.

As described above, one or more examples of the disclosure may involve a controller and peripheral devices which are BLE devices that operate according to the BTCS. In one or more other examples, the controller and peripheral devices are different types of devices, for example, different types of short-range, low-power, and/or low-throughput wireless communication devices, and perform communication operations according to a different predefined specification. As a few examples, the peripheral devices may perform communication operations in accordance with ZIGBEE®, Z-WAVE®, or 6LoWPAN (Internet Protocol (IP) version 6 over Low-power Wireless Personal Area Network). ZIGBEE® is a registered trademark of the Connectivity Standards Alliance of Davis, California, USA. Z-WAVE® is a registered trademark of the Z-Wave Alliance of Beaverton, Oregon, USA.

Accordingly, the peripheral devices may be more generally referred to as wireless communication devices (“wireless devices”); low-power wireless devices; short-range wireless devices; short-range, low-power wireless devices; or short-range, low-power, low-throughput wireless devices. The predefined specification that defines the communication operations of the peripheral devices may be more generally referred to as a predefined communication specification; a predefined specification for short-range communications; a predefined specification for short-range, low-power communications; or a predefined specification for short-range, low-power, low-throughput communications.

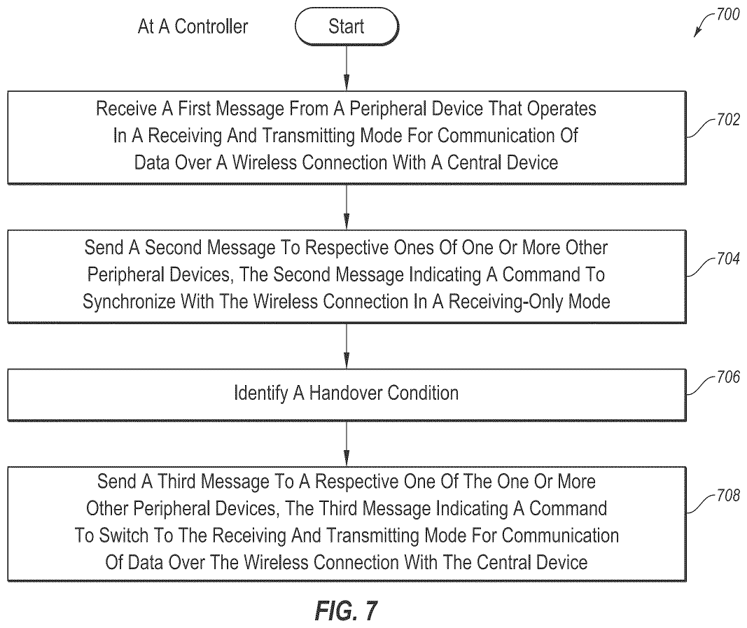

FIG. 7 is a flowchart for describing a method 700 of performing communication operations for seamless handover of a wireless connection, according to one or more examples.

In one or more examples, method 700 of FIG. 7 may be performed by a controller (e.g., controller 202 of FIGS. 2A and 2B, and FIGS. 5A, 5B, 5C, and 5D). In one or more examples, the method may be embodied in an apparatus (e.g., a controller) comprising one or more processors and a memory to store processor-executable code including processor-executable instructions to adapt or enable the one or more processors to perform the acts of the method. In one or more examples, the method may be embodied in a non-transitory processor-readable medium that stores the processor-executable instructions that, when executed by the one or more processors of a controller, cause the one or more processors to perform operations including the acts of the method.

At an act 702, a first message may be received from a peripheral device that operates in a receiving and transmitting mode for communication of data over a wireless connection with a central device. At an act 704, a second message may be sent to respective ones of one or more other peripheral devices. The second message indicates a command to synchronize with the wireless connection in a receiving-only mode. At an act 706, a handover condition may be identified. An act 708 may be performed at least partially responsive to identifying the handover condition in act 706. In the act 708, a third message may be sent to a respective one of the one or more other peripheral devices. The third message indicates a command to switch to the receiving and transmitting mode for communication of data over the wireless connection with the central device.

In one or more examples, at least partially responsive to identifying the handover condition, a fourth message may be sent to the peripheral device. The fourth message indicates a command to switch to the receiving-only mode.

In one or more examples, receiving the first message in act 702 may comprise receiving the first message including connection information comprising parameters of the wireless connection between the central device and the peripheral device. In one or more examples, sending the second message in act 704 may comprise sending the second message including a copy of the connection information.

In one or more examples, sending the second message in act 704 is at least partially responsive to receiving the first message from the peripheral device in act 702.

In one or more examples, the first message may comprise a first command response message. In one or more examples, the method may further include sending a first command message to the peripheral device. The first command message indicates a command to read and respond with connection information, and the connection information comprises parameters of the wireless connection between the central device and the peripheral device.

In one or more examples, sending the first command message indicating the command to read and respond with the connection information comprises sending the first command message comprising a vendor-specific command of an HCI.

In one or more examples, the method may further include receiving signal strength, location, or distance information from the peripheral device that operates in the receiving and transmitting mode. In addition, the method may further include receiving one or more other signal strength, location, or distance information from respective ones of the one or more other peripheral devices that operate in the receiving-only mode. Even further, the method may include identifying the handover condition at least partially based on the signal strength, location, or distance information and the one or more other signal strength, location, or distance information.

In one or more examples, sending the second message indicating the command to synchronize with the wireless connection in the receiving-only mode in act 704 causes respective ones of the one or more other peripheral devices operate a respective transmitter in a reduced transmit power mode or in a powered down transmitter mode. In one or more examples, sending the second message indicating the command to synchronize with the wireless connection in the receiving-only mode in act 704 causes respective ones of the one or more other peripheral devices to receive and discard payload data received over the wireless connection with the central device.

In one or more examples, sending the second message indicating the command to synchronize with the wireless connection in the receiving-only mode in act 704 comprises sending the second message comprising a vendor-specific command of an HCI.

In one or more examples, sending the third message indicating the command to switch to the receiving and transmitting mode for communication of data over the wireless connection with the central device in act 708 comprises sending the third message comprising a vendor-specific command of an HCI.

In one or more examples, respective ones of the peripheral device, the one or more other peripheral devices, and the central device comprise BLE devices.

In one or more examples, the method is performed by the controller adapted to communicate over wired connections with respective ones of the peripheral device and the one or more other peripheral devices.

In one or more examples, the method is performed by the controller adapted to invoke vehicle access control functions responsive to signals received from the central device via a respective peripheral device that operates in the receiving and transmitting mode.

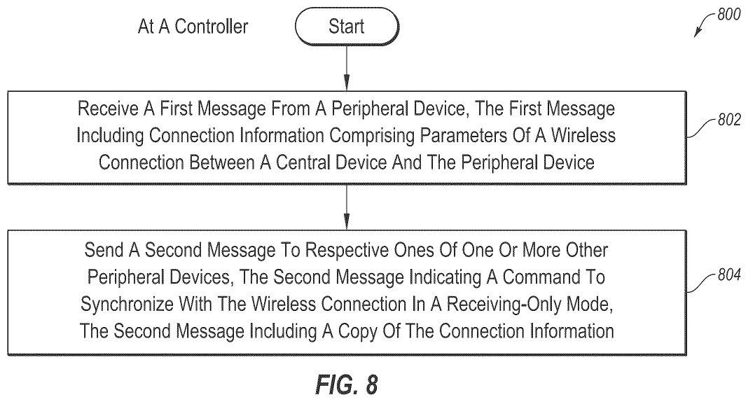

FIG. 8 is a flowchart for describing a method 800 of performing communication operations for seamless handover of a wireless connection, according to one or more examples.

In one or more examples, method 800 of FIG. 8 may be performed by a controller (e.g., controller 202 of FIGS. 2A and 2B, and FIGS. 5A, 5B, 5C, and 5D). In one or more examples, the method may be embodied in an apparatus (e.g., a controller) comprising one or more processors and a memory to store processor-executable code including processor-executable instructions to adapt or enable the one or more processors to perform the acts of the method. In one or more examples, the method may be embodied in a non-transitory processor-readable medium that stores the processor-executable instructions that, when executed by the one or more processors of a controller, cause the one or more processors to perform operations including the acts of the method.

At an act 802, a first message may be received from a peripheral device. The first message includes connection information comprising parameters of a wireless connection between a central device and the peripheral device. At an act 804, a second message may be sent to respective ones of one or more other peripheral devices. The second message indicates a command to synchronize with the wireless connection in a receiving-only mode. The second message includes a copy of the connection information.

In one or more examples, sending the second message in act 804 is at least partially responsive to receiving the first message in act 802.

In one or more examples, the peripheral device may operate in a receiving and transmitting mode to communicate data over the wireless connection with the central device. Here, the method may further include, at least partially responsive to identifying a handover condition, sending a third message to the peripheral device. The third message indicates a command to switch to the receiving-only mode for reception of data over the wireless connection with the central device. In one or more examples, the method may further include, at least partially responsive to identifying the handover condition, sending a fourth message to a respective one of the one or more other peripheral devices. The fourth message indicates a command to switch to the receiving and transmitting mode for communication of data over the wireless connection with the central device.

In one or more examples, the method may further include receiving signal strength, location, or distance information from the peripheral device that operates in the receiving and transmitting mode. In addition, the method may further include receiving one or more other signal strength, location, or distance information from respective ones of the one or more other peripheral devices that operate in the receiving-only mode. Even further, the method may include identifying the handover condition at least partially based on the signal strength, location, or distance information and the one or more other signal strength, location, or distance information.

In one or more examples, the first message may comprise a first command response message. Here, the method may further include sending a first command message to the peripheral device. The first command message indicates a command to read and respond with the connection information. In one or more examples, sending the first command message indicating the command to read and respond with the connection information may comprise sending the first command message comprising a vendor-specific command of an HCI.

In one or more examples, sending the second message indicating the command to synchronize with the wireless connection in the receiving-only mode in act 804 may comprise sending the second message comprising a vendor-specific command of an HCI.

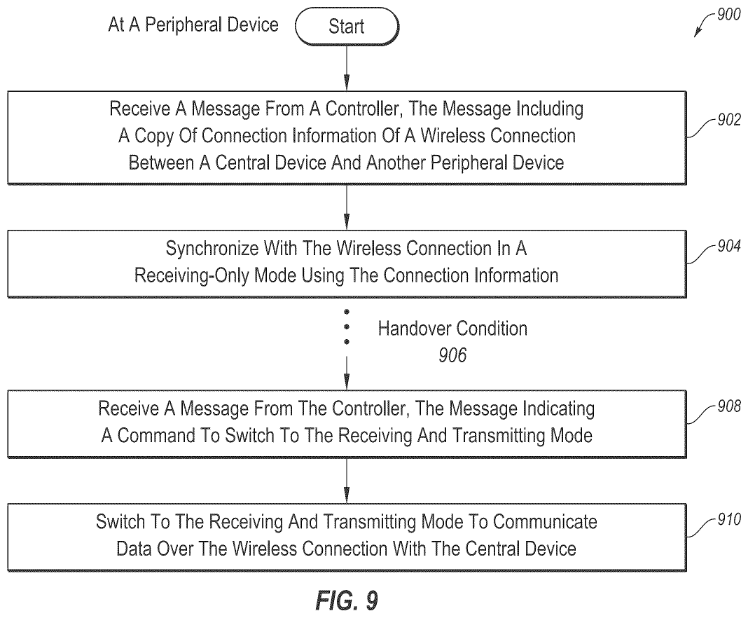

FIG. 9 is a flowchart for describing a method 900 of performing communication operations for seamless handover of a wireless connection, according to one or more examples.

In one or more examples, method 900 of FIG. 9 may be performed by a peripheral device (e.g., peripheral device 214 of FIGS. 2A and 2B, and FIGS. 5A, 5B, 5C, and 5D). In one or more examples, the method may be embodied in an apparatus (e.g., a peripheral device) comprising one or more processors and a memory to store processor-executable code including processor-executable instructions to adapt or enable the one or more processors to perform the acts of the method. In one or more examples, the method may be embodied in a non-transitory processor-readable medium that stores the processor-executable instructions that, when executed by the one or more processors of a peripheral device, cause the one or more processors to perform operations including the acts of the method.

At an act 902, a message may be received from a controller. The message includes a copy of connection information of a wireless connection between a central device and another peripheral device. At an act 904, at least partially responsive to receiving the message, the peripheral device may synchronize with the wireless connection in a receiving-only mode using the connection information.

Sometime during operation, a handover condition may be identified, at an act 906 (e.g., performed at the controller). At an act 908, a message may then be received from the controller. The message indicates a command to switch to the receiving and transmitting mode. At least partially responsive to receiving the second message, at an act 910, the peripheral device may switch to the receiving and transmitting mode for communication of data over the wireless connection with the central device.

In one or more examples, receiving the message indicating the command to switch to the receiving and transmitting mode may comprise a vendor-specific command of an HCI.

In one or more examples, the peripheral device may be synchronized with the wireless connection in the receiving-only mode while the other peripheral device operates in a receiving and transmitting mode for communication of data over the wireless connection with the central device.

In one or more examples, a message may be sent to the controller. The message includes a received signal strength indication.

In one or more examples, in the receiving-only mode, the peripheral device may operate a transmitter in a reduced transmit power mode or in a powered down transmitter mode.

In one or more examples, in the receiving-only mode, the peripheral device may operate to receive and discard payload data received over the wireless connection with the central device.

In one or more examples, receiving the message in act 904 may comprise receiving the message indicating a command to synchronize with the wireless connection in the receiving-only mode, where the command comprises a vendor-specific command of an HCI.

In one or more examples, the peripheral device may comprise a BLE device.

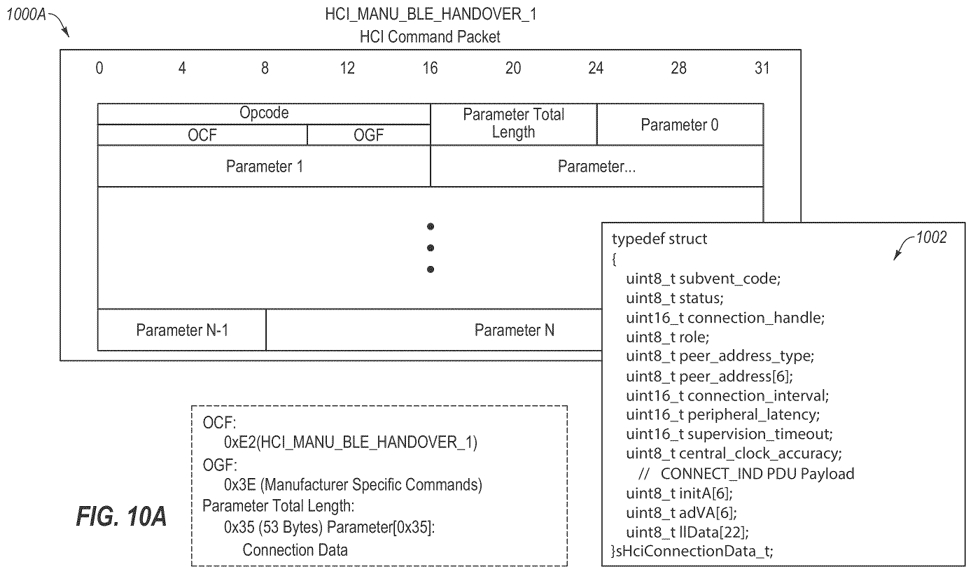

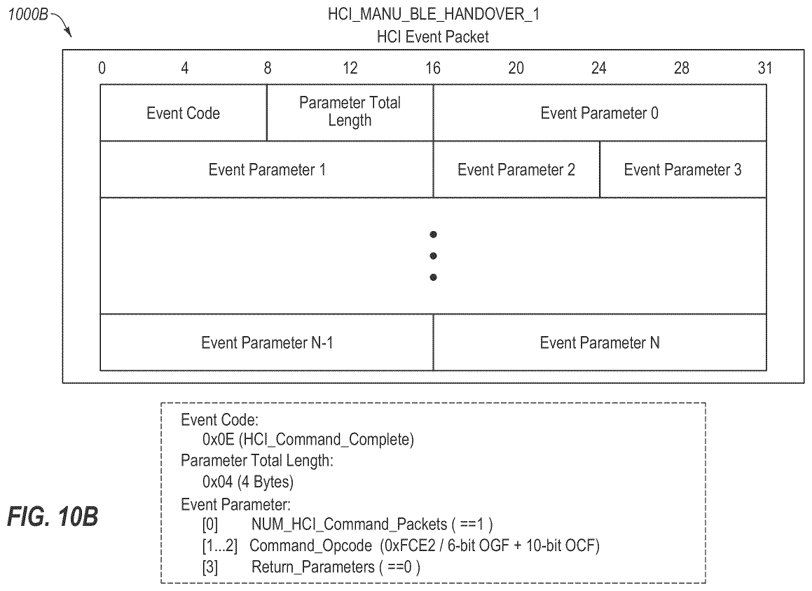

As described above, vendor-specific commands of the HCI may be utilized in the methods, apparatuses, and systems of the disclosure, according to one or more examples. In one or more examples, vendor-specific commands (OGF=0x3F) and events are shown and described in relation to FIGS. 10A-10B, 11A-11B, and 12A-12B.

FIG. 10A is an example packet structure, format and definition of an HCI command packet 1000A for a vendor-specific command referred to as HCI_MANU_BLE_HANDOVER_1, according to one or more examples. In one or more examples, HCI command packet 1000A of FIG. 10A corresponds to command 402 of FIG. 4. FIG. 10B is an example packet structure, format and definition of an HCI event packet 1000B for a vendor-specific event referred to as HCI_MANU_BLE_HANDOVER_1, according to one or more examples. In one or more examples, the HCI_MANU_BLE_HANDOVER_1 command (FIG. 10A) is sent to all unconnected peripheral devices and contains the connection information of the connected peripheral device. The connection information may comprise parameters 1002 of the wireless connection as indicated in FIG. 10A. In response to receipt and processing of the command, respective ones of the peripheral devices send a command complete response (FIG. 10B) to the controller. Parameters 1002 indicated in FIG. 10A include one or more of a subevent code, a status, a connection handle, a role, a peer address type, a peer address, a connection interval, a peripheral latency, a supervision timeout, a central clock accuracy, and so on.

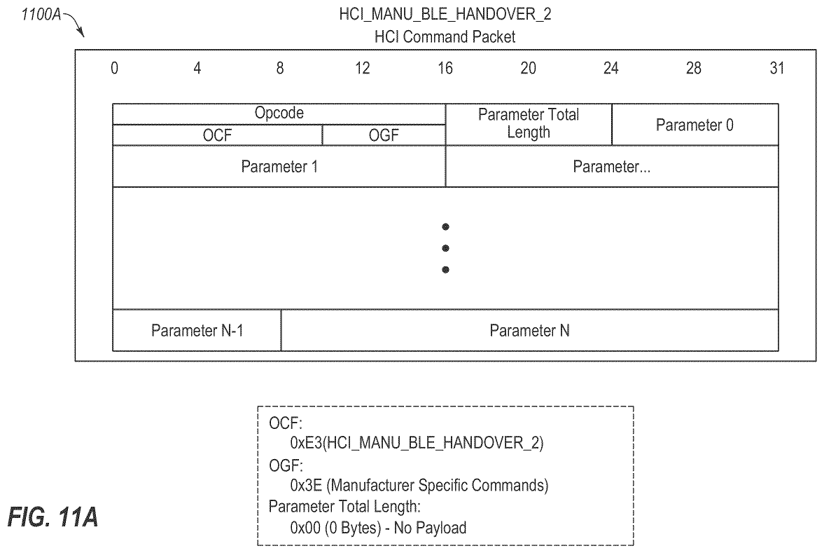

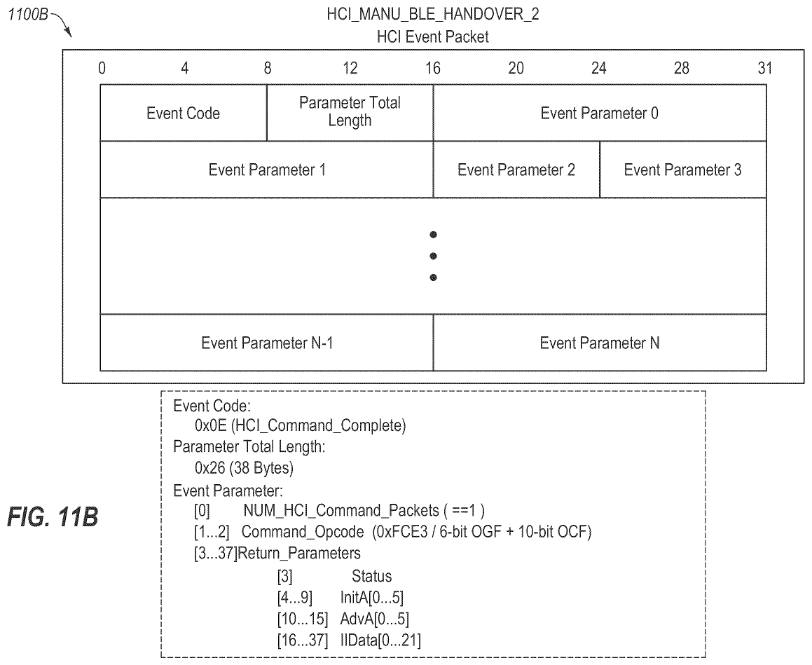

FIG. 11A is an example packet structure, format and definition of an HCI command packet 1100A for a vendor-specific command referred to as HCI_MANU_BLE_HANDOVER_2, according to one or more examples. In one or more examples, HCI command packet 1100A of FIG. 11A corresponds to command 404 of FIG. 4. FIG. 11B is an example packet structure, format and definition of an HCI event packet 1100B for a vendor-specific event referred to as HCI_MANU_BLE_HANDOVER_2, according to one or more examples. In one or more examples, the HCI_MANU_BLE_HANDOVER_2 command (FIG. 11A) is a command to read out the connection information of the connected device. The peripheral device sends a command complete response (FIG. 11B) with the connection information to the car controller.

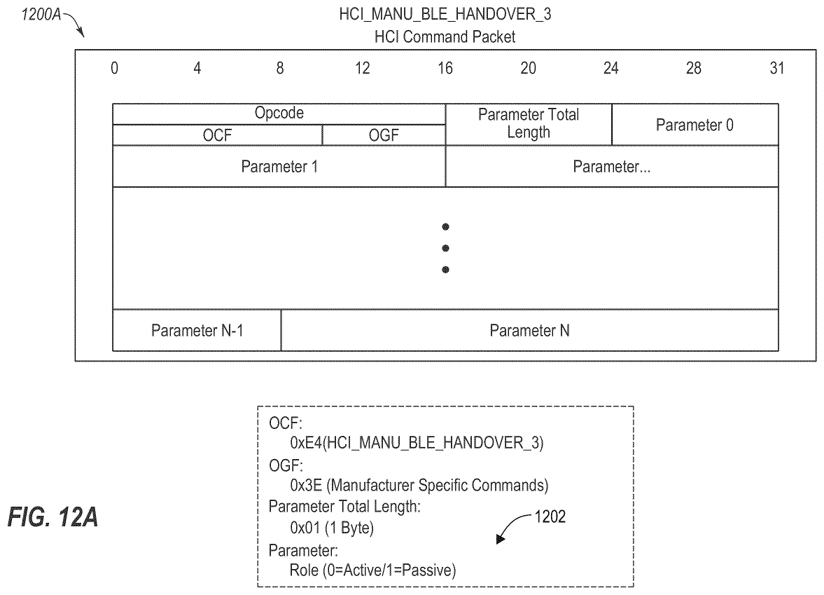

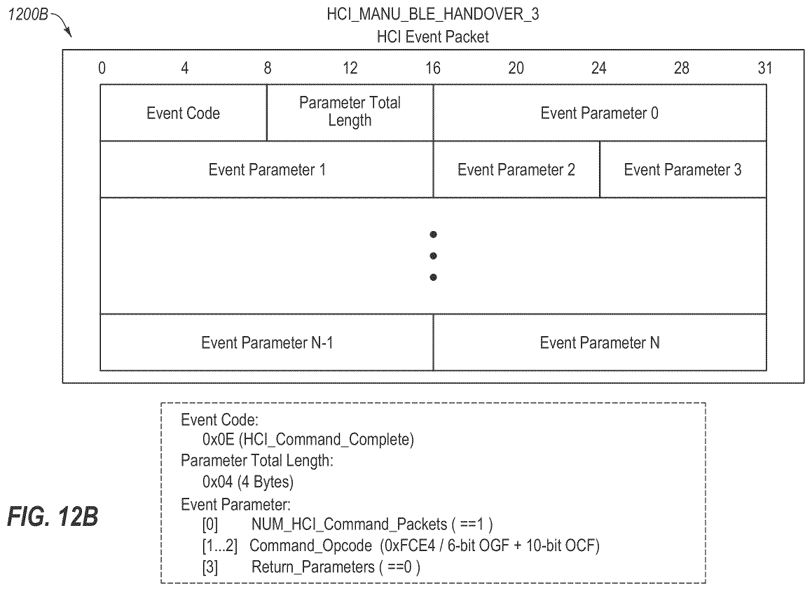

FIG. 12A is an example packet structure, format and definition of an HCI command packet 1200A for a vendor-specific command referred to as HCI_MANU_BLE_HANDOVER_3, according to one or more examples. In one or more examples, HCI command packet 1200A of FIG. 12A corresponds to command 406 of FIG. 4. FIG. 12B is an example packet structure, format and definition of an HCI event packet 1200B for a vendor-specific event referred to as HCI_MANU_BLE_HANDOVER_3, according to one or more examples. The HCI_MANU_BLE_HANDOVER_3 command (FIG. 12A) is a command sent if an “active” peripheral device is to be set to the passive mode, and/or if a “passive” peripheral device is to be set to the active mode. In one or more examples, the command includes a parameter 1202 or indication to indicate a “Role” of Active or Passive for setting the peripheral device to the active mode or the passive mode. The peripheral devices send a command complete response (FIG. 12B) to the controller after the command is processed on the peripheral device.

Thus, vendor-specific commands and events of the HCI (e.g., shown and described in relation to FIGS. 10A-10B, 11A-11B, and 12A-12B) may be utilized in various apparatus of the disclosure, according to one or more examples.

In one or more examples, an apparatus may comprise a controller. Here, the apparatus comprising the controller includes one or more processors and a memory to store processor-executable instructions to adapt or enable the one or more processors to perform operations. The operations include communicating with respective ones of multiple peripheral devices via a host controller interface, where the host controller interface is used to transport commands and events therebetween. The commands and events include predefined commands and events according to a predefined specification. The commands and events further include vendor-specific commands and events allowed by the predefined specification.

More specifically, the vendor-specific commands and events include a vendor-specific command to synchronize with an existing wireless connection in a receiving-only mode. In one or more examples, the vendor-specific command is to specify parameters of the existing wireless connection between a central device and one of the multiple peripheral devices. In one or more examples, the vendor-specific commands and events further include a vendor-specific command to read and respond with connection information of an existing wireless connection. In one or more examples, the vendor-specific commands and events further include a vendor-specific command to switch to a receiving and transmitting mode for communication of data over a wireless connection with the central device.

In one or more examples, the respective ones of the multiple peripheral devices comprise BLE devices. In one or more examples, the predefined specification comprises the BLCS.

In one or more examples, the apparatus comprising the controller is to communicate over wired connections with the respective ones of the multiple peripheral devices. In one or more examples, the apparatus comprising the controller is to invoke vehicle access control functions responsive to signals received from the central device via one of the multiple peripheral devices, and the central device is or is part of a mobile device adapted for smart vehicle access.

In one or more examples, the apparatus comprising the controller may operate to execute a method of performing communication operations for seamless handover of a wireless connection, according to one or more examples. The method may comprise communicating with respective ones of multiple peripheral devices via a host controller interface, where the host controller interface is used to transport commands and events therebetween. The commands and events include predefined commands and events according to a predefined specification. The commands and events further include vendor-specific commands and events allowed by the predefined specification.

The communicating may include sending a first vendor-specific command to a first one of the multiple peripheral devices, where the first vendor-specific command is to read and respond with connection information of an existing wireless connection. In one or more examples, the existing wireless connection is between a central device and the first one of the multiple peripheral devices. The communicating may include receiving a first vendor-specific event from the first one of the multiple peripheral devices responsive to the sending of the first vendor-specific command, where the first vendor-specific event includes parameters of the existing wireless connection. The communicating may include sending a second vendor-specific command to a second one of the multiple peripheral devices, where the second vendor-specific command is to synchronize with the existing wireless connection in a receiving-only mode, the second vendor-specific command includes the parameters of the existing wireless connection.

In one or more examples, the communicating may include sending a third vendor-specific command to the second one of the multiple peripheral devices, where the third vendor-specific command includes a first indication to switch to a receiving and transmitting mode for communication of data over a wireless connection with the central device. In one or more examples, the communicating may include sending the third vendor-specific command to the first one of the multiple peripheral devices, where the third vendor-specific command includes a second indication to switch to the receiving-only mode with the central device.

In one or more examples, the method is performed at the controller which is adapted to communicate over wired connections with the respective ones of the multiple peripheral devices comprising BLE devices.

In one or more examples, an apparatus may comprise a peripheral device. Here, the apparatus comprising the peripheral device includes one or more processors and a memory to store processor-executable instructions to adapt or enable the one or more processors to perform operations. The operations include communicating with a controller via a host controller interface, where the host controller interface is used to transport commands and events therebetween. The commands and events include predefined commands and events according to a predefined specification. The commands and events further include vendor-specific commands and events allowed by the predefined specification.

More specifically, the vendor-specific commands and events include a vendor-specific command to synchronize with an existing wireless connection in a receiving-only mode. In one or more examples, the apparatus comprises a first one of multiple peripheral devices operably coupled to the controller, the existing wireless connection is between a central device and a second one of the multiple peripheral devices operably coupled to the controller, and the vendor-specific command is to specify parameters of the existing wireless connection. In one or more examples, the apparatus comprising the peripheral device is to synchronize with the existing wireless connection in the receiving-only mode responsive to receiving the vendor-specific command. In one or more examples, the vendor-specific command further includes a vendor-specific command to switch to a receiving and transmitting mode for communication of data over a wireless connection with the central device. In one or more examples, the apparatus comprising the peripheral device is to communicate with respective ones of the multiple peripheral devices via the host controller interface, wherein the predefined commands and events according to the predefined specification include at least an advertisement and a connection request. In one or more examples, the apparatus comprising the peripheral device comprises a BLE device. In one or more examples, the predefined specification comprises the BTCS.

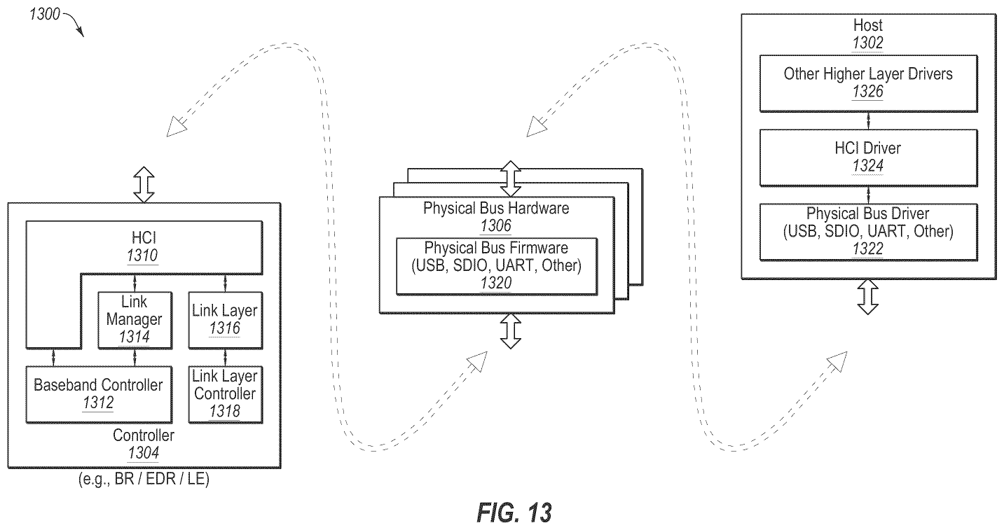

FIG. 13 is an overview of lower software layers of a software stack 1300 which may be utilized in the methods, apparatus, and systems described herein, according to one or more examples. The overview of FIG. 13 is based on FIG. 1.1 of page 1735 of the BTCS, Version 5.3.

A host 1302 may be connected to a controller 1304 for communication via a physical bus hardware 1306. Physical bus hardware 1306 may include a physical bus firmware module 1320 (e.g., a Universal Serial Bus (USB), a Secure Digital Input Output (SDIO), a UART, or other). Host 1302, which may be implemented in a controller (e.g., controller 202 of FIGS. 2A and 2B), includes a physical bus driver 1322 to interface with physical bus hardware 1306, an HCI driver 1324, and other high layer drivers 1326. Controller 1304, which may be implemented in a peripheral device (e.g., peripheral device 212 of FIGS. 2A and 2B), includes an HCI 1310 to interface with physical bus hardware 1306, a baseband controller 1312 to interface with HCI 1310 directly and/or through a link manager 1314, and a link layer controller 1318 to interface with HCI 1310 through a link layer 1316. Controller 1304 may be a Bit Rate (BR), an Enhanced Data Rate (EDR), and/or a Low Energy (LE) controller.

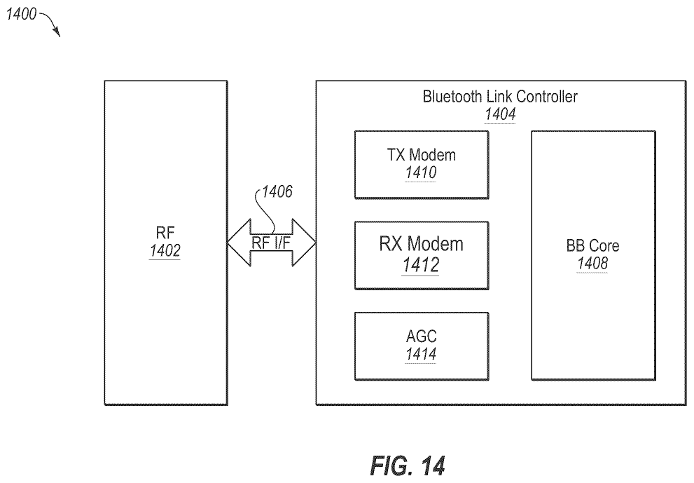

FIG. 14 is a schematic block diagram of a radio frequency (RF) subsystem 1400 which may be utilized in the methods, apparatus, and systems described herein, according to one or more examples. RF subsystem 1400 may be utilized in a controller of the BLE architecture (e.g., the “CONTROLLER” portion of BLE architecture 300 of FIG. 3, and/or controller 1304 of FIG. 13). In one or more examples, the controller of the BLE architecture is implemented in at least part of a peripheral device (e.g., respective ones of multiple peripheral devices 210 of FIGS. 2A and 2B) and/or a central device (e.g., central device 208 of FIGS. 2A and 2B). RF subsystem 1400 include an RF module 1402 for RF communication and a controller module 1404. RF module 1402 and controller module 1404 are operably coupled via an RF intermediate frequency (I/F) signal or interface 1406. Controller module 1404 includes a baseband (BB) core module 1408, a transmitter modem 1410 operably coupled to BB core module 1408, and a receiver modem 1412 operably coupled to BB core module 1408. Controller module 1404 may further include an automatic gain control (AGC) module 1414 operably coupled to receiver modem 1412 and BB core module 1408.

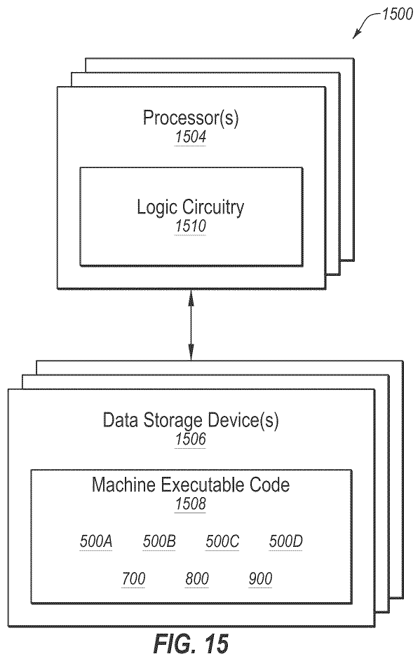

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 15 illustrates non-limiting examples of implementations of functional elements disclosed herein. In some examples, some or all portions of the functional elements disclosed herein may be performed by hardware specially programmed for carrying out the functional elements.

FIG. 15 is a block diagram of a device 1500 that, in one or more examples, may be used to implement various functions, operations, acts, processes, or methods disclosed herein. Device 1500 includes one or more processors 1504 (sometimes referred to herein as “processors 1504”) operably coupled to one or more apparatuses such as data storage devices (sometimes referred to herein as “storage 1506”), without limitation. Storage 1506 includes machine executable code 1508 stored thereon (e.g., stored on a computer-readable memory, without limitation) and processors 1504 include logic circuitry 1510. Machine executable code 1508 may be alternatively referred to as processor-executable code or instructions. Machine executable code 1508 include information describing functional elements that may be implemented by (e.g., performed by) logic circuitry 1510. Logic circuitry 1510 implements (e.g., performs) the functional elements described by machine executable code 1508. Device 1500, when executing the functional elements described by machine executable code 1508, should be considered as special purpose hardware may carry out the functional elements disclosed herein. In one or more examples, processors 1504 may perform the functional elements described by machine executable code 1508 sequentially, concurrently (e.g., on one or more different hardware platforms), or in one or more parallel process streams.

In one or more examples, device 1500 may be or include at least portions of a controller, a peripheral device, or a central device, described in relation to the previous figures. When implemented by logic circuitry 1510 of processors 1504, machine executable code 1508 may adapt processors 1504 to perform operations of examples disclosed herein. For example, machine executable code 1508 may adapt processors 1504 to perform at least a portion or a totality of the operations discussed in relation to controller 202 of FIGS. 2A and 2B; FIGS. 5A, 5B, 5C, and 5D; and FIGS. 7 and 8; respective ones of multiple peripheral devices 210 of FIGS. 2A and 2B; FIGS. 5A, 5B, 5C, and 5D; and FIG. 9; and more specifically, one or more operations indicated FIGS. 5A, 5B, 5C, and 5D, and FIGS. 7, 8, and 9, without limitation.

Processors 1504 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes computing instructions (e.g., software code, without limitation) related to examples. It is noted that a general-purpose processor (may also be referred to herein as a host processor or simply a host) may be a microprocessor, but in the alternative, processors 1504 may include any conventional processor, controller, microcontroller, or state machine. Processors 1504 may also be implemented as a combination of computing devices, such as a combination of a DSP and a microprocessor, a plurality of microprocessors, one or more microprocessors in conjunction with a DSP core, or any other such configuration.

In one or more examples, storage 1506 includes volatile data storage (e.g., random-access memory (RAM), without limitation), non-volatile data storage (e.g., Flash memory, a hard disc drive, a solid state drive, erasable programmable read-only memory (EPROM), without limitation). In one or more examples processors 1504 and storage 1506 may be implemented into a single device (e.g., a semiconductor device product, a system on chip (SOC), without limitation). In one or more examples processors 1504 and storage 1506 may be implemented into separate devices.

In one or more examples, machine executable code 1508 may include computer-readable instructions (e.g., software code, firmware code, without limitation). By way of non-limiting example, the computer-readable instructions may be stored by storage 1506, accessed directly by processors 1504, and executed by processors 1504 using at least logic circuitry 1510. Also by way of non-limiting example, the computer-readable instructions may be stored on storage 1506, transmitted to a memory device (not shown) for execution, and executed by processors 1504 using at least logic circuitry 1510. Accordingly, in one or more examples logic circuitry 1510 includes electrically configurable logic circuitry.

In one or more examples, machine executable code 1508 may describe hardware (e.g., circuitry, without limitation) to be implemented in logic circuitry 1510 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, Verilog™, System Verilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 1510 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in one or more examples machine executable code 1508 may include an HDL, an RTL, a GL description, a mask level description, other hardware description, or any combination thereof.

In examples where machine executable code 1508 includes a hardware description (at any level of abstraction), a system (not shown, but including storage 1506) may implement the hardware description described by machine executable code 1508. By way of non-limiting example, processors 1504 may include a programmable logic device (e.g., an FPGA or a PLC, without limitation) and the logic circuitry 1510 may be electrically controlled to implement circuitry corresponding to the hardware description into logic circuitry 1510. Also by way of non-limiting example, logic circuitry 1510 may include hard-wired logic manufactured by a manufacturing system (not shown, but including storage 1506) according to the hardware description of machine executable code 1508.

Regardless of whether machine executable code 1508 includes computer-readable instructions or a hardware description, logic circuitry 1510 performs the functional elements described by machine executable code 1508 when implementing the functional elements of machine executable code 1508. It is noted that although a hardware description may not directly describe functional elements, a hardware description indirectly describes functional elements that the hardware elements described by the hardware description are capable of performing.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

As used in the present disclosure, the terms “module” or “component” may refer to specific hardware implementations may perform the actions of the module or component or software objects or software routines that may be stored on or executed by general purpose hardware (e.g., computer-readable media, processing devices, without limitation) of the computing system. In one or more examples, the different components, modules, engines, and services described in the present disclosure may be implemented as objects or processes that execute on the computing system (e.g., as separate threads, without limitation). While some of the system and methods described in the present disclosure are generally described as being implemented in software (stored on or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

A non-exhaustive, non-limiting list of examples follows. Not each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Additional non-limiting examples of the disclosure include:

Example 1: An apparatus, comprising: one or more processors; a memory to store processor-executable instructions to adapt or enable the one or more processors to: communicate with respective ones of multiple peripheral devices via a host controller interface, the host controller interface used to transport commands and events therebetween; the commands and events including predefined commands and events according to a predefined specification; and the commands and events further including vendor-specific commands and events allowed by the predefined specification, the vendor-specific commands and events including: a vendor-specific command to synchronize with an existing wireless connection in a receiving-only mode.

Example 2: The apparatus according to Example 1, wherein the vendor-specific command is to specify parameters of the existing wireless connection between a central device and one of the multiple peripheral devices.

Example 3: The apparatus according to any of Examples 1 and 2, wherein the vendor-specific command comprises a first vendor-specific command, and the vendor-specific commands and events further include: a second vendor-specific command to read and respond with connection information of an existing wireless connection.

Example 4: The apparatus according to any of Examples 1 through 3, wherein the vendor-specific commands and events further include: a third vendor-specific command to switch to a receiving and transmitting mode for communication of data over a wireless connection with the central device.

Example 5: The apparatus according to any of Examples 1 through 4, wherein the apparatus comprises a controller to communicate over wired connections with the respective ones of the multiple peripheral devices.

Example 6: The apparatus according to any of Examples 1 through 5, wherein the controller is to invoke vehicle access control functions responsive to signals received from a central device via one of the multiple peripheral devices, and the central device is or is part of a mobile device adapted for smart vehicle access.

Example 7: The apparatus according to any of Examples 1 through 6, wherein the respective ones of the multiple peripheral devices comprise BLUETOOTH® Low Energy (BLE) devices.

Example 8: The apparatus according to any of Examples 1 through 7, wherein the predefined specification comprises a BLUETOOTH® Core Specification.

Example 9: A method comprising: communicating with respective ones of multiple peripheral devices via a host controller interface, the host controller interface used to transport commands and events therebetween, the commands and events including predefined commands and events according to a predefined specification, the commands and events further including vendor-specific commands and events allowed by the predefined specification, the communicating including: sending a first vendor-specific command to a first one of the multiple peripheral devices, the first vendor-specific command to read and respond with connection information of an existing wireless connection; receiving a first vendor-specific event from the first one of the multiple peripheral devices responsive to the sending of the first vendor-specific command, the first vendor-specific event including parameters of the existing wireless connection; and sending a second vendor-specific command to a second one of the multiple peripheral devices, the second vendor-specific command to synchronize with the existing wireless connection in a receiving-only mode, the second vendor-specific command including the parameters of the existing wireless connection.

Example 10: The method according to Example 9, wherein the existing wireless connection is between a central device and the first one of the multiple peripheral devices.

Example 11: The method according to any of Examples 9 and 10, wherein the communicating includes: sending a third vendor-specific command to the second one of the multiple peripheral devices, the third vendor-specific command including a first indication to switch to a receiving and transmitting mode for communication of data over a wireless connection with the central device.

Example 12: The method according to any of Examples 9 through 11, wherein the communicating includes: sending the third vendor-specific command to the first one of the multiple peripheral devices, the third vendor-specific command including a second indication to switch to the receiving-only mode with the central device.

Example 13: The method according to any of Examples 9 through 12, wherein the method is performed at a controller adapted to communicate over wired connections with the respective ones of the multiple peripheral devices comprising BLUETOOTH® Low Energy (BLE) devices.

Example 14: An apparatus, comprising: one or more processors; a memory to store processor-executable instructions to adapt or enable the one or more processors to: communicate with a controller via a host controller interface, the host controller interface used to transport commands and events therebetween; the commands and events including predefined commands and events according to a predefined specification; and the commands and events further including vendor-specific commands and events allowed by the predefined specification, the vendor-specific commands and events including: a vendor-specific command to synchronize with an existing wireless connection in a receiving-only mode.

Example 15: The apparatus according to Example 14, wherein the apparatus comprises a first one of multiple peripheral devices operably coupled to the controller, the existing wireless connection is between a central device and a second one of the multiple peripheral devices operably coupled to the controller, and the vendor-specific command is to specify parameters of the existing wireless connection.

Example 16: The apparatus according to any of Examples 14 and 15, wherein the processor-executable instructions are to adapt or enable the one or more processors to: synchronize with the existing wireless connection in the receiving-only mode responsive to receiving the vendor-specific command.

Example 17: The apparatus according to any of Examples 14 through 16, wherein the vendor-specific command comprises a first vendor-specific commend, and the vendor-specific commands and events further include: a second vendor-specific command to switch to a receiving and transmitting mode for communication of data over a wireless connection with the central device.

Example 18: The apparatus according to any of Examples 14 through 17, wherein the processor-executable instructions are to adapt or enable the one or more processors to: communicate with respective ones of multiple peripheral devices via the host controller interface, wherein the predefined commands and events according to the predefined specification include at least an advertisement and a connection request.

Example 19: The apparatus according to any of Examples 14 through 18, wherein the predefined specification comprises a BLUETOOTH® Core Specification.

Example 20: The apparatus according to any of Examples 14 through 19, wherein the apparatus comprises a BLUETOOTH® Low Energy (BLE) device.

Example 1: A method comprising: at a controller, receiving a first message from a peripheral device that operates in a receiving and transmitting mode for communication of data over a wireless connection with a central device; sending a second message to respective ones of one or more other peripheral devices, the second message indicating a command to synchronize with the wireless connection in a receiving-only mode; and at least partially responsive to identifying a handover condition, sending a third message to a respective one of the one or more other peripheral devices, the third message indicating a command to switch to the receiving and transmitting mode for communication of data over the wireless connection with the central device.

Example 2: The method according to Example 1, comprising: at the controller, at least partially responsive to identifying the handover condition, sending a fourth message to the peripheral device, the fourth message indicating a command to switch to the receiving-only mode.

Example 3: The method according to any of Examples 1 and 2, wherein: receiving the first message comprises receiving the first message including connection information comprising parameters of the wireless connection between the central device and the peripheral device, and sending the second message comprises sending the second message including a copy of the connection information.

Example 4: The method according to any of Examples 1 through 3, wherein sending the second message is at least partially responsive to receiving the first message from the peripheral device.

Example 5: The method according to any of Examples 1 through 4, wherein the first message comprises a first command response message, the method comprising: sending a first command message to the peripheral device, the first command message indicating a command to read and respond with connection information, the connection information comprising parameters of the wireless connection between the central device and the peripheral device.

Example 6: The method according to any of Examples 1 through 5, wherein sending the first command message indicating the command to read and respond with the connection information comprises sending the first command message comprising a vendor-specific command of a host controller interface (HCI).

Example 7: The method according to any of Examples 1 through 6, comprising: at the controller, receiving signal strength, location, or distance information from the peripheral device that operates in the receiving and transmitting mode; receiving one or more other signal strength, location, or distance information from respective ones of the one or more other peripheral devices that operate in the receiving-only mode; and identifying the handover condition at least partially based on the signal strength, location, or distance information and the one or more other signal strength, location, or distance information.

Example 8: The method according to any of Examples 1 through 7, wherein sending the second message indicating the command to synchronize with the wireless connection in the receiving-only mode causes respective ones of the one or more other peripheral devices operate a respective transmitter in a reduced transmit power mode or in a powered down transmitter mode.

Example 9: The method according to any of Examples 1 through 8, wherein sending the second message indicating the command to synchronize with the wireless connection in the receiving-only mode causes respective ones of the one or more other peripheral devices to receive and discard payload data received over the wireless connection with the central device.

Example 10: The method according to any of Examples 1 through 9, wherein sending the second message indicating the command to synchronize with the wireless connection in the receiving-only mode comprises sending the second message comprising a vendor-specific command of a host controller interface (HCI).

Example 11: The method according to any of Examples 1 through 10, wherein sending the third message indicating the command to switch to the receiving and transmitting mode for communication of data over the wireless connection with the central device comprises sending the third message comprising a vendor-specific command of a host controller interface (HCI).

Example 12: The method according to any of Examples 1 through 11, wherein respective ones of the peripheral device, the one or more other peripheral devices, and the central device comprise BLUETOOTH® Low Energy (BLE) devices.

Example 13: The method according to any of Examples 1 through 12, wherein the method is performed by the controller adapted to communicate over wired connections with respective ones of the peripheral device and the one or more other peripheral devices.

Example 14: The method according to any of Examples 1 through 13, wherein the method is performed by the controller adapted to invoke vehicle access control functions responsive to signals received from the central device via a respective peripheral device that operates in the receiving and transmitting mode.

Example 15: An apparatus, comprising: one or more processors; and a memory to store processor-executable instructions to adapt or enable the one or more processors to: receive a first message from a peripheral device that operates in a receiving and transmitting mode for communication of data over a wireless connection with a central device; send a second message to respective ones of one or more other peripheral devices, the second message indicating a command to synchronize with the wireless connection in a receiving-only mode; and at least partially responsive to identifying a handover condition, send a third message to a respective one of the one or more other peripheral devices, the third message indicating a command to switch to the receiving and transmitting mode for communication of data over the wireless connection with the central device.

Example 16: The apparatus according to Example 15, wherein the processor-executable instructions are to adapt or enable the one or more processors to: at least partially responsive to identifying the handover condition, send a fourth message to the peripheral device, the fourth message indicating a command to switch to the receiving-only mode.

Example 17: The apparatus according to any of Examples 15 and 16, wherein the processor-executable instructions are to adapt or enable the one or more processors to: receive the first message by receiving the first message including connection information comprising parameters of the wireless connection between the central device and the peripheral device, and send the second message by sending the second message including a copy of the connection information.

Example 18: The apparatus according to any of Examples 15 through 17, wherein to send the second message is at least partially responsive to receiving the first message from the peripheral device.

Example 19: The apparatus according to any of Examples 15 through 18, wherein the first message comprises a first command response message, and the processor-executable instructions are to cause the one or more processors of a controller to perform the operations comprising: sending a first command message to the peripheral device, the first command message indicating a command to read and respond with connection information, the connection information comprising parameters of the wireless connection between the central device and the peripheral device.

Example 20: The apparatus according to any of Examples 15 through 19, wherein sending the first command message indicating the command to read and respond with the connection information comprises sending the first command message comprising a vendor-specific command of a host controller interface (HCI).

Example 21: A method comprising: at a controller, receiving a first message from a peripheral device, the first message including connection information comprising parameters of a wireless connection between a central device and the peripheral device; and sending a second message to respective ones of one or more other peripheral devices, the second message indicating a command to synchronize with the wireless connection in a receiving-only mode, the second message including a copy of the connection information.

Example 22: The method according to Example 21, wherein: sending the second message is at least partially responsive to receiving the first message.

Example 23: The method according to any of Examples 21 and 22, wherein the peripheral device operates in a receiving and transmitting mode to communicate data over the wireless connection with the central device, the method comprising: at the controller, at least partially responsive to identifying a handover condition, sending a third message to the peripheral device, the third message indicating a command to switch to the receiving-only mode for reception of data over the wireless connection with the central device.

Example 24: The method according to any of Examples 21 through 23, comprising: at the controller, at least partially responsive to identifying the handover condition, sending a fourth message to a respective one of the one or more other peripheral devices, the fourth message indicating a command to switch to the receiving and transmitting mode for communication of data over the wireless connection with the central device.

Example 25: The method according to any of Examples 21 through 24, comprising: at the controller, receiving signal strength, location, or distance information from the peripheral device; receiving one or more other signal strength, location, or distance information from respective ones of the one or more other peripheral devices; and identifying a handover condition at least partially based on the signal strength, location, or distance information and the one or more other signal strength, location, or distance information.

Example 26: The method according to any of Examples 21 through 25, wherein the first message comprises a first command response message, the method comprising: sending a first command message to the peripheral device, the first command message indicating a command to read and respond with the connection information.

Example 27: The method according to any of Examples 21 through 26, wherein sending the first command message indicating the command to read and respond with the connection information comprises sending the first command message comprising a vendor-specific command of a host controller interface (HCI).

Example 28: The method according to any of Examples 21 through 27, wherein sending the second message indicating the command to synchronize with the wireless connection in the receiving-only mode comprises sending the second message comprising a vendor-specific command of a host controller interface (HCI).

Example 29: A method comprising: at a peripheral device, receiving a message from a controller, the message including a copy of connection information of a wireless connection between a central device and another peripheral device; and at least partially responsive to receiving the message, synchronizing with the wireless connection in a receiving-only mode using the connection information.

Example 30: The method according to Example 29, wherein the message comprises a first message, the method comprising: at the peripheral device, receiving a second message from the controller, the second message indicating a command to switch to the receiving and transmitting mode; and at least partially responsive to receiving the second message, switching to the receiving and transmitting mode for communication of data over the wireless connection with the central device.

Example 31: The method according to any of Examples 29 and 30, wherein receiving the second message indicating the command to switch to the receiving and transmitting mode comprises a vendor-specific command of a host controller interface (HCI).

Example 32: The method according to any of Examples 29 through 31, wherein the peripheral device is synchronized with the wireless connection in the receiving-only mode while the other peripheral device operates in a receiving and transmitting mode for communication of data over the wireless connection with the central device.

Example 33: The method according to any of Examples 29 through 32, wherein the message comprises a first message, the method comprising: at the peripheral device, sending a second message to the controller, the second message including a received signal strength indication.

Example 34: The method according to any of Examples 29 through 33, comprising: at the peripheral device, in the receiving-only mode, operating a transmitter in a reduced transmit power mode or in a powered down transmitter mode.

Example 35: The method according to any of Examples 29 through 34, comprising: at the peripheral device, in the receiving-only mode, operating to receive and discard payload data received over the wireless connection with the central device.

Example 36: The method according to any of Examples 29 through 35, wherein receiving the message comprises receiving the message indicating a command to synchronize with the wireless connection in the receiving-only mode, the command comprising a vendor-specific command of a host controller interface (HCI).

Example 37: The method according to any of Examples 29 through 36, wherein the peripheral device comprises a BLUETOOTH® Low Energy (BLE) device.

Example 38: A non-transitory processor-readable medium to store processor-executable instructions that, when executed by one or more processors of a peripheral device, cause the one or more processors to perform operations comprising: receiving a message from a controller, the message including a copy of connection information of a wireless connection between a central device and another peripheral device; and at least partially responsive to receiving the message, connecting to the central device using the connection information for synchronization with the wireless connection in a receiving-only mode.

Example 39: The non-transitory processor-readable medium according to Example 38, wherein the message comprises a first message, and the processor-executable instructions are to cause the one or more processors of the peripheral device to perform the operations comprising: receiving a second message from the controller, the second message indicating a command to switch to the receiving and transmitting mode; and at least partially responsive to receiving the second message, switching to the receiving and transmitting mode for communication of data over the wireless connection with the central device.

Example 40: The non-transitory processor-readable medium according to any of Examples 38 and 39, wherein receiving the second message indicating the command to switch to the receiving and transmitting mode comprises a vendor-specific command of a host controller interface (HCI).

Example 41: The non-transitory processor-readable medium according to any of Examples 38 through 40, wherein the peripheral device is synchronized with the wireless connection in the receiving-only mode while the other peripheral device operates in a receiving and transmitting mode for communication of data over the wireless connection with the central device.

Example 42: The non-transitory processor-readable medium according to any of Examples 38 through 41, wherein the message comprises a first message, and the processor-executable instructions are to cause the one or more processors of the peripheral device to perform the operations comprising: sending a second message to the controller, the second message including a received signal strength indication.

Example 43: The non-transitory processor-readable medium according to any of Examples 38 through 42, wherein the processor-executable instructions are to cause the one or more processors of the peripheral device to perform the operations comprising: in the receiving-only mode, operating a transmitter in a reduced transmit power mode or in a powered down transmitter mode.

Example 44: The non-transitory processor-readable medium according to any of Examples 38 through 43, wherein the processor-executable instructions are to cause the one or more processors of the peripheral device to perform the operations comprising: in the receiving-only mode, operating to receive and discard payload data received over the wireless connection with the central device.

Example 45: The non-transitory processor-readable medium according to any of Examples 38 through 44, wherein receiving the message comprises receiving the message indicating a command to synchronize with the wireless connection in the receiving-only mode, the command comprising a vendor-specific command of a host controller interface (HCI).

What is claimed is:

1. A method comprising:
at a controller,
receiving a first message from a peripheral device that operates in a receiving and transmitting mode for communication of data over a wireless connection with a central device;
sending a second message to respective ones of one or more other peripheral devices, the second message indicating a command to synchronize with the wireless connection in a receiving-only mode; and
at least partially responsive to identifying a handover condition, sending a third message to a respective one of the one or more other peripheral devices, the third message indicating a command to switch to the receiving and transmitting mode for communication of data over the wireless connection with the central device.

2. The method of claim 1, comprising:
at the controller,
at least partially responsive to identifying the handover condition, sending a fourth message to the peripheral device, the fourth message indicating a command to switch to the receiving-only mode.

3. The method of claim 1, wherein:
receiving the first message comprises receiving the first message including connection information comprising parameters of the wireless connection between the central device and the peripheral device, and
sending the second message comprises sending the second message including a copy of the connection information.

4. The method of claim 1, wherein sending the second message is at least partially responsive to receiving the first message from the peripheral device.

5. The method of claim 1, wherein the first message comprises a first command response message, the method comprising:
sending a first command message to the peripheral device, the first command message indicating a command to read and respond with connection information, the connection information comprising parameters of the wireless connection between the central device and the peripheral device.

6. The method of claim 5, wherein sending the first command message indicating the command to read and respond with the connection information comprises sending the first command message comprising a vendor-specific command of a host controller interface (HCI).

7. The method of claim 1, comprising:
at the controller,
receiving signal strength, location, or distance information from the peripheral device that operates in the receiving and transmitting mode;
receiving one or more other signal strength, location, or distance information from respective ones of the one or more other peripheral devices that operate in the receiving-only mode; and
identifying the handover condition at least partially based on the signal strength, location, or distance information and the one or more other signal strength, location, or distance information.

8. The method of claim 1, wherein sending the second message indicating the command to synchronize with the wireless connection in the receiving-only mode causes respective ones of the one or more other peripheral devices operate a respective transmitter in a reduced transmit power mode or in a powered down transmitter mode.

9. The method of claim 1, wherein sending the second message indicating the command to synchronize with the wireless connection in the receiving-only mode causes respective ones of the one or more other peripheral devices to receive and discard payload data received over the wireless connection with the central device.

10. The method of claim 1, wherein sending the second message indicating the command to synchronize with the wireless connection in the receiving-only mode comprises sending the second message comprising a vendor-specific command of a host controller interface (HCI).

11. The method of claim 1, wherein sending the third message indicating the command to switch to the receiving and transmitting mode for communication of data over the wireless connection with the central device comprises sending the third message comprising a vendor-specific command of a host controller interface (HCI).

12. The method of claim 1, wherein respective ones of the peripheral device, the one or more other peripheral devices, and the central device comprise BLUETOOTH® Low Energy (BLE) devices.

13. The method of claim 12, wherein the method is performed by the controller adapted to communicate over wired connections with respective ones of the peripheral device and the one or more other peripheral devices.

14. The method of claim 13, wherein the method is performed by the controller adapted to invoke vehicle access control functions responsive to signals received from the central device via a respective peripheral device that operates in the receiving and transmitting mode.

15. An apparatus, comprising:
one or more processors; and
a memory to store processor-executable instructions to adapt or enable the one or more processors to:
receive a first message from a peripheral device that operates in a receiving and transmitting mode for communication of data over a wireless connection with a central device;
send a second message to respective ones of one or more other peripheral devices, the second message indicating a command to synchronize with the wireless connection in a receiving-only mode; and
at least partially responsive to identifying a handover condition, send a third message to a respective one of the one or more other peripheral devices, the third message indicating a command to switch to the receiving and transmitting mode for communication of data over the wireless connection with the central device.

16. The apparatus of claim 15, wherein the processor-executable instructions are to adapt or enable the one or more processors to:
at least partially responsive to identifying the handover condition, send a fourth message to the peripheral device, the fourth message indicating a command to switch to the receiving-only mode.

17. The apparatus of claim 15, wherein the processor-executable instructions are to adapt or enable the one or more processors to:
receive the first message by receiving the first message including connection information comprising parameters of the wireless connection between the central device and the peripheral device, and
send the second message by sending the second message including a copy of the connection information.

18. The apparatus of claim 15, wherein to send the second message is at least partially responsive to receiving the first message from the peripheral device.

19. The apparatus of claim 15, wherein the first message comprises a first command response message, and the processor-executable instructions are to cause the one or more processors of a controller to perform the operations comprising:
sending a first command message to the peripheral device, the first command message indicating a command to read and respond with connection information, the connection information comprising parameters of the wireless connection between the central device and the peripheral device.

20. The apparatus of claim 19, wherein sending the first command message indicating the command to read and respond with the connection information comprises sending the first command message comprising a vendor-specific command of a host controller interface (HCI).

21. A method comprising:
at a controller,
receiving a first message from a peripheral device, the first message including connection information comprising parameters of a wireless connection between a central device and the peripheral device; and
sending a second message to respective ones of one or more other peripheral devices, the second message indicating a command to synchronize with the wireless connection in a receiving-only mode, the second message including a copy of the connection information.

22. The method of claim 21, wherein:
sending the second message is at least partially responsive to receiving the first message.

23. The method of claim 21, wherein the peripheral device operates in a receiving and transmitting mode to communicate data over the wireless connection with the central device, the method comprising:
at the controller,
at least partially responsive to identifying a handover condition, sending a third message to the peripheral device, the third message indicating a command to switch to the receiving-only mode for reception of data over the wireless connection with the central device.

24. The method of claim 23, comprising:
at the controller,
at least partially responsive to identifying the handover condition, sending a fourth message to a respective one of the one or more other peripheral devices, the fourth message indicating a command to switch to the receiving and transmitting mode for communication of data over the wireless connection with the central device.

25. The method of claim 21, comprising:
at the controller,
receiving signal strength, location, or distance information from the peripheral device;
receiving one or more other signal strength, location, or distance information from respective ones of the one or more other peripheral devices; and
identifying a handover condition at least partially based on the signal strength, location, or distance information and the one or more other signal strength, location, or distance information.

26. The method of claim 21, wherein the first message comprises a first command response message, the method comprising:
sending a first command message to the peripheral device, the first command message indicating a command to read and respond with the connection information.

27. The method of claim 26, wherein sending the first command message indicating the command to read and respond with the connection information comprises sending the first command message comprising a vendor-specific command of a host controller interface (HCI).

28. The method of claim 21, wherein sending the second message indicating the command to synchronize with the wireless connection in the receiving-only mode comprises sending the second message comprising a vendor-specific command of a host controller interface (HCI).

29. A method comprising:
at a peripheral device,
receiving a message from a controller, the message including a copy of connection information of a wireless connection between a central device and another peripheral device; and
at least partially responsive to receiving the message, synchronizing with the wireless connection in a receiving-only mode using the connection information.

30. The method of claim 29, wherein the message comprises a first message, the method comprising:
at the peripheral device,
receiving a second message from the controller, the second message indicating a command to switch to the receiving and transmitting mode; and
at least partially responsive to receiving the second message, switching to the receiving and transmitting mode for communication of data over the wireless connection with the central device.

31. The method of claim 30, wherein receiving the second message indicating the command to switch to the receiving and transmitting mode comprises a vendor-specific command of a host controller interface (HCI).

32. The method of claim 29, wherein the peripheral device is synchronized with the wireless connection in the receiving-only mode while the other peripheral device operates in a receiving and transmitting mode for communication of data over the wireless connection with the central device.

33. The method of claim 29, wherein the message comprises a first message, the method comprising:
at the peripheral device,
sending a second message to the controller, the second message including a received signal strength indication.

34. The method of claim 29, comprising:
at the peripheral device,
in the receiving-only mode, operating a transmitter in a reduced transmit power mode or in a powered down transmitter mode.

35. The method of claim 29, comprising:
at the peripheral device,
in the receiving-only mode, operating to receive and discard payload data received over the wireless connection with the central device.

36. The method of claim 29, wherein receiving the message comprises receiving the message indicating a command to synchronize with the wireless connection in the receiving-only mode, the command comprising a vendor-specific command of a host controller interface (HCI).

37. The method of claim 29, wherein the peripheral device comprises a BLUETOOTH® Low Energy (BLE) device.

38. A non-transitory processor-readable medium to store processor-executable instructions that, when executed by one or more processors of a peripheral device, cause the one or more processors to perform operations comprising:
receiving a message from a controller, the message including a copy of connection information of a wireless connection between a central device and another peripheral device; and
at least partially responsive to receiving the message, connecting to the central device using the connection information for synchronization with the wireless connection in a receiving-only mode.

39. The non-transitory processor-readable medium of claim 38, wherein the message comprises a first message, and the processor-executable instructions are to cause the one or more processors of the peripheral device to perform the operations comprising:
receiving a second message from the controller, the second message indicating a command to switch to the receiving and transmitting mode; and
at least partially responsive to receiving the second message, switching to the receiving and transmitting mode for communication of data over the wireless connection with the central device.

40. The non-transitory processor-readable medium of claim 39, wherein receiving the second message indicating the command to switch to the receiving and transmitting mode comprises a vendor-specific command of a host controller interface (HCI).

41. The non-transitory processor-readable medium of claim 38, wherein the peripheral device is synchronized with the wireless connection in the receiving-only mode while the other peripheral device operates in a receiving and transmitting mode for communication of data over the wireless connection with the central device.

42. The non-transitory processor-readable medium of claim 38, wherein the message comprises a first message, and the processor-executable instructions are to cause the one or more processors of the peripheral device to perform the operations comprising:
sending a second message to the controller, the second message including a received signal strength indication.

43. The non-transitory processor-readable medium of claim 38, wherein the processor-executable instructions are to cause the one or more processors of the peripheral device to perform the operations comprising:
in the receiving-only mode, operating a transmitter in a reduced transmit power mode or in a powered down transmitter mode.

44. The non-transitory processor-readable medium of claim 38, wherein the processor-executable instructions are to cause the one or more processors of the peripheral device to perform the operations comprising:
in the receiving-only mode, operating to receive and discard payload data received over the wireless connection with the central device.

45. The non-transitory processor-readable medium of claim 38, wherein receiving the message comprises receiving the message indicating a command to synchronize with the wireless connection in the receiving-only mode, the command comprising a vendor-specific command of a host controller interface (HCI).
